(19) United States
(12) Patent Application Publication
(10) Pub. No.: US 2017/0360075 A1
(43) Pub. Date: Dec. 21, 2017

(54) MEDICAL FOOD FOR THE TREATMENT OF MALARIA AND/OR IRON DEFICIENCY

(71) Applicant: The Penn State Research Foundation, University Park, PA (US)

(72) Inventors: James R. Connor, Hershey, PA (US); Dominique Leitner, New York, NY (US); Jose A. Stoute, Hummelstown, PA (US)

(21) Appl. No.: 15/535,090

(22) PCT Filed: Dec. 10, 2015
(86) PCT No.: PCT/US15/64903

§ 371 Date: Jun. 12, 2017

Related U.S. Application Data
(60) Provisional application No. 62/090,663, filed on Dec. 11, 2014.

(51) Int. Cl. A23L 33/00; A23L 33/15; A23L 33/125; A23L 33/16; A23L 33/115; A23L 2/02; A23L 33/17

(52) U.S. Cl. CPC A23L 33/40; A23L 2/02; A23L 33/15; A23L 33/17; A23L 33/16; A23L 33/115; A23L 33/125

(57) ABSTRACT

The present invention encompasses compositions and methods for treating or preventing malaria, compositions and methods for treating or preventing iron deficiency, and compositions and methods for simultaneously treating or preventing malaria and iron deficiency.

### CROSS-REFERENCE TO RELATED APPLICATIONS

This application claims priority to U.S. Provisional Application Ser. No. 62/090,663, filed Dec. 11, 2014, the content of which is incorporated by reference herein in its entirety.

### BACKGROUND OF THE INVENTION

There are about five million cases of cerebral malaria (CM) per year, predominantly in children of Sub-Saharan Africa and also in South East Asia. CM is a severe malarial infection caused by the parasite Plasmodium falciparum. The neurological symptoms include agitation, psychosis, seizures, coma, and death. There is no effective way to prevent malaria in endemic populations and chemoprophylaxis is not recommended due to risk of side effects, poor compliance, and risk of development of resistance. Pesticides are used to reduce mosquito numbers that carry this parasite. Antimalarials are somewhat effective and are used in combination therapies for patients in affected areas; however, there is growing resistance to the current drugs. There is a 15-20% mortality rate associated with CM resulting in about one million deaths a year. If these children survive, they have long term neurological deficits because of brain damage that occurred during the infection including spasticity, ataxia, hemiplegia, speech disorders, blindness, cognitive impairment, and epilepsy. In addition, most of the children in these regions are iron deficient because of their grain based diets. Iron deficiency during development is associated with significant and long term neurological and cognitive effects. Iron deficiency may protect against CM infection, however, there is debate about treating the iron deficiency in these children. Thus, these at-risk children exist in a double jeopardy situation, where they are resigned to suffering the consequences of some form of health risk associated with either iron deficiency or malaria infestation.

Cerebral malaria (CM) occurs in approximately 5 million individuals each year as a result of Plasmodium falciparum infection (WHO, 2000, Trans R Soc Trop Med Hyg, 94 Suppl 1:S1-90; Snow et al., 2005, Nature, 434:214-217). Patients with CM have myelin damage, axonal injury, blood brain barrier (BBB) breakdown, and survivors have neurological deficits (Janota et al., 1979, J Clin Pathol, 32:769-772; Idro et al., 2010, Pediatr Res, 68:267-274; Dorovini-Zis et al., 2011, Am J Pathol, 178:2146-2158; Kampondeni et al., 2013, Am J Trop Med Hyg, 88:542-546). The animal model for CM utilizing the Plasmodium berghei ANKA strain is an experimental model (ECM), but shares similar important aspects of the pathogenesis and clinical features with human CM such as myelin damage, axonal injury, BBB breakdown and development of cognitive deficits (Ma et al., 1997, Glia, 19:135-151; Desruisseaux et al., 2008, J Infect Dis, 197:1621-1627; Miranda et al., 2013, Malar J, 12:388).

Iron deficiency is common in some malaria endemic areas and may influence the inflammatory response and course of the infection (Prentice, 2008, J Nutr, 138:2537-2541; Ganz, 2009, Curr Opin Immunol, 21:63-67; Wessling-Resnick, 2010, Annu Rev Nutr, 30:105-122; Clark et al., 2014, Front Pharmacol, 5:84). Because iron is a cofactor for many enzymes involved in cellular respiration, cell proliferation, neurotransmitter synthesis and myelination, an iron deficiency during postnatal development results in cognitive and motor impairments that are irreversible (Oski et al., 1978, J Pediatr, 92:21-25; Oski et al., 1983, Pediatrics, 71:877-880; DeMaeyer et al., 1985, World Health Stat Q, 38:302-316; Beard, 2000, Am J Clin Nutr, 71:1288S-1294S; Grantham-McGregor et al., 2001, J Nutr, 131:649S-668S; Beard et al., 2003, Dev Neurosci, 25:308-315; Ortiz et al., 2004, J Neurosci Res, 77:681-689; Lozoff et al., 2006, Nutr Rev, 64:S34-43, S72-91; Lozoff et al., 2006, Semin Pediatr Neurol, 13:158-165). Thus, postnatal iron deficiency leads to long-term neurological deficits (Oski et al., 1978, J Pediatr, 92:21-25; Oski et al., 1983, Pediatrics, 71:877-880; Grantham-McGregor et al., 2001, J Nutr, 131:649S-668S; Lozoff et al., 2006, Nutr Rev, 64:S34-43, S72-91; Lozoff et al., 2006, Semin Pediatr Neurol, 13:158-165) and certainly overlays its own negative impact on child development. However, iron supplementation in patients with malaria is controversial because there is a concern that it may increase the severity of the infection (Okebe et al., 2011, Cochrane Database Syst Rev, CD006589). Some studies have shown that individuals with iron deficiency are less susceptible to infections (Jonker et al., 2012, PLoS One, 7:e42670) and in ECM animal models iron deficiency is associated with increased survival and decreased parasitemia (Koka et al., 2007, Biochem Biophys Res Commun, 357:608-614). On the other hand, iron supplements given to iron deficient (ID) children infected with P. falciparum have improved outcome after malaria infection (Sazawal et al., 2006, Lancet, 367:133-143; Ojukwu et al., 2009, Cochrane Database Syst Rev, CD006589; Zlotkin et al., 2013, JAMA, 310:938-947). Consequently, the World Health Organization (WHO) currently recommends that iron supplements be given while a person's malaria status is monitored or while they are under treatment (Okebe et al., 2011, Cochrane Database Syst Rev, CD006589).

There still remains an unmet need in the art for compositions and methods of treating malaria and symptoms associated with malaria infection, and in particular treating malaria and symptoms associated with malaria infection in subjects afflicted with iron deficiency. The present invention satisfies this need.

### SUMMARY OF THE INVENTION

In one aspect, the invention relates to a medical food comprising at least one protein, at least one sugar, at least one fat, at least one vitamin, and at least one mineral. In another aspect, the invention relates to a medical food comprising at least one protein found in casein, sucrose, at least one fat found in corn oil, at least one vitamin selected from the group consisting of thiamin, riboflavin, pyridoxine, niacin, calcium pantothenate, folic acid, biotin, vitamin B12, vitamin A, vitamin E, DL-alpha tocopheryl acetate, vitamin D3, cholecalciferol, and vitamin K, and at least one mineral selected from the group consisting of calcium, phosphorus, potassium, sodium, chlorine, magnesium, copper, iron, zinc, manganese, iodine, and selenium. In one embodiment, the medical food of the invention further comprises methionine, corn starch, and choline. In another embodiment, the casein used in the medical food of the invention is low Cu and Fe casein.

In another aspect, the invention relates to a medical food comprising at least one protein, at least one sugar, at least one fat, at least one vitamin, at least one mineral, and an iron source. In one embodiment, the concentration of iron in the medical food of the invention is from 0 to 1000 mg/Kg. In another embodiment, the iron source in the medical food of the invention is ferric citrate. In one embodiment, choline in the medical food of the invention is in the form of choline bitartrate. In another embodiment, the medical food of the invention further comprises an antioxidant. In another embodiment, the antioxidant is ethoxyquin.

In one aspect, the invention relates to a method for treating or preventing malaria in a subject, the method comprising administering to the subject an effective amount of a medical food of the invention. In another aspect, the invention relates to a method for treating or preventing a malaria associated disorder in a subject, comprising administering to the subject an effective amount of a medical food of the invention. In one embodiment, the malaria associated disorder is cerebral malaria. In another embodiment, the subject is further afflicted with iron deficiency.

In one aspect, the invention relates to a method for treating or preventing iron deficiency in a subject, comprising administering to the subject an effective amount of a medical food of the invention comprising an iron source. In one embodiment, the subject is further afflicted with malaria. In another embodiment, the subject is further afflicted with a malaria associated disorder. In another embodiment, the malaria associated disorder is cerebral malaria.

### BRIEF DESCRIPTION OF THE DRAWINGS

FIG. 1 is a series of charts depicting that infected mice on experimental diets have decreased parasitemia and increased survival. FIG. 1A: iron deficient (ID) infected mice survived throughout the course of the study, and only 20% (2/10) of the infected mice on the preventative diet (PD) died between day 7-8 p.i. (p=0.1464 when comparing experimental diets, Kaplan-Meier survival curve). Mice on standard rodent chow (SC) have 100% mortality by day 6 p.i. The surviving mice were sacrificed on day 14 p.i. for further evaluation. FIG. 1B: parasitemia was significantly decreased in both groups on the experimental diets compared to those on standard rodent chow but there was an elevation of the infection of RBCs on day 6 p.i. for mice on the preventative diet when compared to mice on the iron deficient diet. Values represent averages.

FIG. 2 is a series of charts depicting hematological parameters, which were measured throughout the course of the infection. FIG. 2A: Hct (%) was decreased on day 0 p.i. in ID mice before infection when compared to mice on the preventative diet (PD) and remained relatively low throughout the course of the study. Preventative diet mice had normal Hct levels in the beginning of infection, but this decreased after infection when compared to uninfected mice on the preventative diet at the end of the study. Hct was slightly lower in mice on standard rodent chow (SC) compared to the mice on the preventative diet and was unchanged throughout the course of the study. FIG. 2B: Hgb (g/dL) was decreased on day 0 p.i. in ID mice before infection when compared to mice on the preventative diet and remained lower than the other groups throughout the course of the infection. Mice on the preventative diet had elevated Hgb in both infected and uninfected groups when compared to mice on the standard rodent chow and ID diets but the infected group on the preventative diet decreased to the level seen in the uninfected ID diet group on day 14 p.i. For mice on standard rodent chow, Hgb levels were slightly less than the levels found for mice on the preventative diet and was not significantly altered throughout the course of infection.

FIG. 3 is a chart depicting that plasma Epo is elevated after infection in surviving mice. Epo was elevated after infection in both groups of mice receiving the experimental diets. The Epo levels were significantly higher in the mice on the iron deficient (ID) diet compared to the preventative diet (PD). However, when considering that the two animals in the preventative diet group that died had the lowest levels of Epo, the results among surviving mice are similar. Mice on the standard rodent chow (SC) did not have a significant change in Epo levels after infection. Plasma was isolated from mice when they were moribund or at the end of the study in surviving mice. Epo levels were evaluated by ELISA, and a four parameter logistic curve was used to calculate plasma Epo from a standard curve. Two-way ANOVA with Bonferroni post-hoc test was used to determine significance. Values represent averages. **p<0.01; ***p<0.001.

FIG. 4 is a chart depicting that plasma IL-6 is not elevated after infection in mice on experimental diets. IL-6 levels were not different from uninfected mice after infection in mice on the experimental diets. The highest IL-6 levels in the preventative (PD) diet group were found in the mice that died. Thus, when considering that the two animals in the preventative diet group that died had higher levels of IL-6, the results among surviving mice are similar. Mice on the standard rodent chow (SC) had significantly elevated levels of IL-6 and all had died by day 6 p.i. Plasma was isolated from mice when they were moribund or at the end of the study in surviving mice. IL-6 levels were evaluated by ELISA, and a four parameter logistic curve was used to calculate plasma IL-6 from a standard curve. Two-way ANOVA with Bonferroni post-hoc test was used to determine significance. Values represent averages. **p<0.01.

FIG. 5 is a series of charts and photos depicting that myelin basic protein expression is decreased in the brain of mice after Plasmodium berghei ANKA strain infection. FIGS. 5A and 5B: C57BL/6 female mice (8 weeks old) were infected with P. berghei ANKA strain for 7 days. The myelin fraction was isolated from uninfected and experimental cerebral malaria-infected brains for quantification of myelin basic protein levels by western blot. Myelin basic protein expression levels were decreased in the infected animals for both the 21 kDa and 18 kDa isoforms. Values represent averages ±S.E.M. of 15 mice in two experiments. Protein quantification is relative to the beta-actin loading control. A Student's t test was used to determine significance. *P<0.05. FIG. 5C shows the results of an experiment set to determine whether the effect of myelin basic protein loss influenced the corpus callosum, wherein immunohistochemistry was performed to evaluate the relative levels of myelin basic protein immunostaining. Histologically, the intensity of staining for myelin basic protein (red) was decreased in the corpus callosum of the infected mice compared with the control mice. Representative images are depicted with DAPI (blue) at 10× magnification.

FIG. 6 is a series of charts and photos depicting that Sema4A protein expression is increased in the brain of mice after Plasmodium berghei ANKA strain infection. FIGS. 6A and 6B: C57BL/6 female mice (8 weeks old) were infected with P. berghei ANKA strain for 7 days. In the total brain homogenate, Sema4A protein expression levels were increased for the 80 kDa form and unchanged for the 120 kDa form. Values represent averages ±S.E.M. of 15 mice in two experiments. Protein quantification is relative to the beta-actin loading control. A Student's t test was used to determine significance. **P<0.01. FIG. 6C: histologically, Sema4A staining (green) is increased in cellular clusters of the frontal cortex in infected mice. Representative images are depicted with DAPI (blue) at 10× magnification.

FIG. 7 is a series of charts depicting that infected iron deficient and H67D HFE iron overload mice have decreased parasitemia and increased survival after Plasmodium berghei ANKA strain infection. FIG. 7A: parasitemia was significantly decreased in formulated iron deficient diet mice on day 6 p.i. compared with formulated iron adequate diet mice. Parasitemia was elevated in wild type mice on standard rodent chow on day 8 p.i. FIG. 7B: parasitemia was significantly decreased in H67D mice on day 6 p.i. compared with H67H wild type mice (P=0.0125), using repeated measures two-way ANOVA followed by Tukey's post-hoc test. It should be noted that decreased parasitemia on day 10 p.i. indicates infected red blood cells, not extracellular parasites which were also observed. FIG. 7C: formulated iron deficient diet infected mice survived throughout the course of the study, while 20% of infected formulated iron adequate diet mice died between day 7-8 p.i. (P=0.1464, Kaplan-Meier survival curve). The surviving mice were sacrificed on day 14 p.i. for further evaluation. All wild type mice on a standard rodent chow diet between day 6-8 p.i became moribund. FIG. 7D: Survival of infected H67D mice was significantly increased (P=0.0085, Kaplan-Meier survival curve) compared with H67H mice. The surviving 33% of H67D mice were sacrificed on day 14 p.i. for further evaluation. Values represent averages ±S.E.M. for standard rodent chow (n=5 per group), formulated iron adequate diet (n=5-10 per group), formulated iron deficient diet (n=5-10 per group), H67H (n=8-9 per group), and H67D (n=6 per group) mice. *P<0.05.

FIG. 8 is a series of charts depicting that hematological parameters in mice were altered due to diet, genotype and infection. Hematological parameters were measured throughout the course of the Plasmodium berghei ANKA strain infection.

FIG. 8A: hematocrit (%) was decreased on day 0 p.i. in formulated iron deficient diet mice before infection. Hematocrit continued to stay decreased in formulated iron deficient diet mice throughout the course of the infection. Formulated iron adequate diet mice had a decrease in hematocrit on the last day of infection. FIG. 8B: mean corpuscular volume (fL) was significantly decreased in formulated iron deficient diet mice throughout the course of the infection. On day 14 p.i., mean corpuscular volume was significantly increased for infected formulated iron adequate diet and formulated iron deficient diet mice compared with uninfected mice. FIG. 8C: hematocrit (%) was elevated in H67D iron overload mice on day 0 p.i., which decreased to H67H wild type levels in infected H67D mice until day 10 p.i. when it continued to decrease further. FIG. 8D: mean corpuscular volume (fL) was significantly higher in H67D mice throughout the course of the infection. On day 14 p.i., mean corpuscular volume was significantly increased for infected H67D mice compared with uninfected H67D mice (P=0.0176). Mean corpuscular volume did not change throughout the course of the infection in the infected H67H mice. Values represent averages ±S.E.M. Repeated measures two-way ANOVA followed by Tukey's post-hoc test was used for analysis. *P<0.05; **P<0.01; ***P<0.001.

FIG. 9 is a series of charts depicting that Plasmodium berghei ANKA strain-infected mice on the formulated iron adequate diet have increased survival, decreased parasitemia, and similar hematological parameters compared with mice on standard rodent chow. FIG. 9A: survival of infected formulated iron adequate diet mice was significantly increased (P<0.001, Kaplan-Meier survival curve) compared with standard rodent chow mice. The surviving mice were sacrificed on day 22 p.i. for further evaluation. FIG. 9B: parasitemia was significantly lower in formulated iron adequate diet mice on day 6 p.i. compared with standard rodent chow mice, but became elevated in formulated iron adequate diet mice after day 8 p.i. FIG. 9C: mean corpuscular volume (fL) was not significantly different in formulated iron adequate diet or standard rodent chow mice, but continued to increase in formulated iron adequate diet mice throughout the course of the infection. FIG. 9D: red blood cell density (106/uL) was not significantly different in formulated iron adequate diet or standard rodent chow mice, but continued to decrease in formulated iron adequate diet mice throughout the course of the infection. Values represent averages ±S.E.M. for standard rodent chow (n=15 per group) and formulated iron adequate diet (n=25 per group) mice. *P<0.05.

FIG. 10 is a series of charts depicting that murine brain iron homeostatic proteins, TfR and Hft, are altered by diet, genotype and Plasmodium berghei ANKA strain infection. Iron homeostatic proteins were evaluated in whole brain. FIGS. 10A and 10B: TfR was significantly increased in formulated iron deficient diet mice before infection, but was no longer significant after infection. FIGS. 10A and 10C: Hft tended to decrease in formulated iron deficient diet mice before infection. After infection, there was a significant decrease in formulated iron deficient diet mice compared with infected formulated iron adequate diet mice. FIGS. 10D and 10F: TfR was significantly decreased in H67D iron overload mice before and after infection. TfR decreased after infection in H67H wild type mice. FIGS. 10E and 10G: Hft was significantly increased in H67D mice, which significantly decreased after infection. However, Hft remained elevated in infected H67D mice compared with infected H67H mice. Representative western blot images are depicted. Protein quantification is relative to the beta-actin loading control. Two-way ANOVA with Bonferroni post-hoc test was used to determine significance. Values represent averages. *P<0.05;**P<0.01; ***P<0.001.

FIG. 11 is a series of charts depicting that murine brain iron homeostatic proteins, Tim2 and CXCR4, are altered by diet, genotype and Plasmodium berghei ANKA strain infection. Receptors that interact with ferritin were evaluated in whole brain of mice on the formulated iron adequate diet and formulated iron deficient diet. FIGS. 11A and 11B: Tim2 was significantly increased in formulated iron deficient diet mice and remained increased after infection. FIGS. 11A and 11C: CXCR4 tended to decrease in formulated iron deficient diet mice and increased after infection. FIGS. 11D and 11F: Tim2 was significantly increased in H67D iron overload mice and decreased after infection. FIGS. 11E and 11G: CXCR4 was not altered by genotype or infection. Representative western blot images are depicted. Protein quantification is relative to the beta-actin loading control. Two-way ANOVA with Bonferroni post-hoc test was used to determine significance. Values represent averages. *P<0.05; **P<0.01; ***P<0.001.

FIG. 12 is a series of charts depicting myelin basic protein expression in the myelin fraction from mouse brain. FIGS. 12A and 12D: the myelin fraction was isolated from the brains of mice on the formulated iron adequate diet and formulated ID diet for myelin basic protein evaluation in uninfected and Plasmodium berghei ANKA strain infected mice. FIG. 12B: the influence of diet on myelin basic protein (21 kDa) was P=0.01 and of infection was P=0.24. FIG. 12C: the influence of diet on myelin basic protein (18 kDa) was P=0.01 and of infection was P=0.31. FIG. 12E: the influence of genotype on myelin basic protein (21 kDa) was P=0.11 and of infection was P=0.02. FIG. 12F: the influence of genotype on myelin basic protein (18 kDa) was P=0.01 and of infection was P=0.08. Representative western blot images are depicted. Protein quantification is relative to the beta-actin loading control. Two-way ANOVA with Bonferroni post-hoc test was used to determine significance. Values represent averages.

FIG. 13 is a series of charts depicting that Sema4A protein expression is increased in mouse brain after infection, but is lower in iron deficient and H67D iron overload mice infected with Plasmodium berghei ANKA strain. FIGS. 13A and 13B: Sema4A levels in the brain were evaluated for formulated iron adequate diet and formulated iron deficient diet (FID) mice by western blot. Day 7-8 p.i. is noted by “*” to indicate the highest brain Sema4A expression found in mice that died earlier. FIG. 13C: Sema4A (80 kDa) was significantly increased in infected formulated iron adequate diet mice that died earlier. There was no significant change in Sema4A levels in surviving formulated iron adequate diet or formulated iron deficient diet mice. FIGS. 13D and 13E: Sema4A levels in the brain were evaluated for H67H wild type and H67D mice by western blot. Day 14 p.i. is noted by “*” to indicate the lowest brain Sema4A expression found in surviving mice. FIG. 13F: Sema4A (80 kDa) was significantly increased in infected mice and was significantly higher in H67H infected mice. Representative western blot images are depicted. Protein quantification is relative to the beta-actin loading control. Two-way ANOVA with Bonferroni post-hoc test was used to determine significance. Values represent averages. ***P<0.001.

FIG. 14 is a series of charts depicting plasma erythropoietin levels in mice infected with Plasmodium berghei ANKA strain. FIG. 14A: erythropoietin was elevated after infection in surviving formulated iron adequate diet and formulated iron deficient diet mice, but not in formulated iron adequate diet mice that died prior to Day 15 p.i. erythropoietin was more increased in infected formulated iron deficient diet mice compared with infected formulated iron adequate diet mice. FIG. 14B: erythropoietin was elevated after infection in surviving H67D iron overload mice. FIG. 14C: there was no difference in plasma erythropoietin levels on day 6 p.i. in mice on the standard rodent chow diet or the formulated iron adequate diet mice. A four parameter logistic curve was used to calculate plasma erythropoietin from a standard curve. Two-way ANOVA with Bonferroni post-hoc test was used to determine significance. Values represent averages. *P<0.05; ***P<0.001.

FIG. 15 is a series of charts depicting plasma IL-6 levels in mice after Plasmodium berghei ANKA strain infection. FIG. 15A: IL-6 was not significantly different between formulated iron adequate (FIA) and formulated iron deficient diet mice. FIG. 15B: IL-6 was not significantly different in uninfected H67H wild type or H67D iron overload mice. After infection, IL-6 was significantly elevated in H67H mice but not in surviving H67D mice. FIG. 15C: plasma was isolated from mice on day 6 p.i. and IL-6 levels were evaluated by ELISA. There was no difference in IL-6 levels between standard rodent chow and FIA mice. A four parameter logistic curve was used to calculate plasma IL-6 from a standard curve. Two-way ANOVA with Bonferroni post-hoc test was used to determine significance. Values represent averages. *P<0.05.

FIG. 16 is a series of tables depicting the components of the Normal Rodent Chow.

### DESCRIPTION OF THE INVENTION

This invention relates to a medical food for treating malaria. This invention also relates to a medical food for treating a disorder associated with malaria. In one embodiment the disorder is cerebral malaria (CM). In another embodiment, the invention is related to a formulation of nutrients that increases the survival rate of a subject infected with malaria. In another embodiment, the invention is related to a formulation of nutrients that increases the survival rate of a subject affected by cerebral malaria.

The invention is partly based on the development of a medical food that was tested in a mouse model of CM that addresses both iron deficiency and blunts the inflammatory response associated with malaria. Accordingly, the invention provided compositions and methods to treat malaria and CM patients. In one embodiment, the invention provides a cost effective and easily manufactured diet that offers both a different approach and more effective treatment for malaria and CM patients.

In one embodiment, the invention provides compositions and methods to reduce the severity of infection and decrease mortality while continuing to promote normal neurological development by providing an adequate level of iron in the diet.

In one embodiment, the invention provides compositions and methods to prevent the severity of symptoms associated with CM and the negative consequences of iron deficiency and improve the long term outcome for children.

In one embodiment, the invention relates to a dietary strategy that combines the ability to limit the inflammatory component and CNS effects of CM while maintaining a normal amount of iron in the diet. In one embodiment, the dietary strategy of the invention does not involve the use of chemotherapeutic drugs to prevent disease.

In one embodiment, the preventive strategies of the invention focus on the prevention of one of the major complications of malaria infection rather than the infection itself.

In one embodiment, the medical food of the invention is manufactured and produced in chewable tablets or bars for easy handling and consumption.

### Definitions

As used herein, each of the following terms has the meaning associated with it in this section.

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, organic chemistry, and peptide chemistry are those well-known and commonly employed in the art.

The articles “a” and “an” are used herein to refer to one or to more than one, i.e., to at least one of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, or ±0.1% from the specified value, as such variations are appropriate to perform the disclosed methods.

The term “or,” as used herein, means “and/or” unless explicitly indicated to refer to alternatives only or the alternatives are mutually exclusive, although the disclosure supports a definition that refers to only alternatives and “and/or.”

The terms “inhibiting,” “reducing,” “preventing,” or “diminishing,” and variations of these terms, as used herein include any measurable decrease, including complete or substantially complete reduction or inhibition.

A “disease” is a state of health of an animal wherein the animal cannot maintain homeostasis, and wherein if the disease is not ameliorated then the animal's health continues to deteriorate.

In contrast, a “disorder” in an animal is a state of health in which the animal is able to maintain homeostasis, but in which the animal's state of health is less favorable than it would be in the absence of the disorder. Left untreated, a disorder does not necessarily cause a further decrease in the animal's state of health.

A disease or disorder is “alleviated” if the severity of a symptom of the disease or disorder, the frequency with which such a symptom is experienced by a patient, or both, is reduced.

An “effective amount,” “therapeutically effective amount,” or “pharmaceutically effective amount” of a compound or composition is that amount of compound or composition which is sufficient to provide a beneficial effect to the subject to which the compound or composition is administered. An “effective amount” of a delivery vehicle is that amount sufficient to effectively bind or deliver a compound.

As used herein, the term “treatment” or “treating” encompasses prophylaxis and/or therapy. Accordingly the compositions and methods of the present invention are not limited to therapeutic applications and can be used in prophylaxis ones. Therefore “treating” or “treatment” of a state, disorder or condition includes: (i) preventing or delaying the appearance of clinical symptoms of the state, disorder or condition developing in a subject that may be afflicted with or predisposed to the state, disorder or condition but does not yet experience or display clinical or subclinical symptoms of the state, disorder or condition, (ii) inhibiting the state, disorder or condition, i.e., arresting or reducing the development of the disease or at least one clinical or subclinical symptom thereof, or (iii) relieving the disease, i.e. causing regression of the state, disorder or condition or at least one of its clinical or subclinical symptoms.

As used herein, the terms “therapy” or “therapeutic regimen” refer to those activities taken to alleviate or alter a disorder or disease state, e.g., a course of treatment intended to reduce or eliminate at least one sign or symptom of a disease or disorder using pharmacological, surgical, dietary and/or other techniques. A therapeutic regimen may include a prescribed dosage of one or more drugs or surgery. Therapies will most often be beneficial and reduce or eliminate at least one sign or symptom of the disorder or disease state, but in some instances the effect of a therapy will have non-desirable or side-effects. The effect of therapy will also be impacted by the physiological state of the subject, e.g., age, gender, genetics, weight, other disease conditions, etc.

A “therapeutic” treatment is a treatment administered to a subject who exhibits signs of pathology, for the purpose of diminishing or eliminating those signs.

As used herein, “treating a disease or disorder” means reducing the frequency with which a symptom of the disease or disorder is experienced by a patient. Disease and disorder are used interchangeably herein.

As used herein, “additional ingredients” include, but are not limited to, one or more of the following: excipients; surface active agents; dispersing agents; inert diluents; granulating and disintegrating agents; binding agents; lubricating agents; sweetening agents; flavoring agents; coloring agents; preservatives; physiologically degradable compositions such as gelatin; aqueous vehicles and solvents; oily vehicles and solvents; suspending agents; dispersing or wetting agents; emulsifying agents; demulcents; buffers; salts; thickening agents; fillers; emulsifying agents; antioxidants; antibiotics; antifungal agents; stabilizing agents; and pharmaceutically and/or nutraceutically acceptable polymeric or hydrophobic materials. Other “additional ingredients” that may be included in the pharmaceutical compositions used in the practice of the invention are known in the art and described, for example in Remington's Pharmaceutical Sciences (Genaro, Ed., Mack Publishing Co., 1985, Easton, Pa.), which is incorporated herein by reference.

The compositions of the present invention can be formulated according to known methods to prepare pharmaceutically and nutraceutically useful compositions, whereby these materials, or their functional derivatives, are combined in admixture with a pharmaceutically or nutraceutically acceptable carrier vehicle. In order to form a pharmaceutically acceptable composition suitable for effective administration, such compositions will contain an effective amount of the herein-described compounds and compositions, macro- and micro-nutrients, for example vitamins and minerals, together with a suitable amount of carrier vehicle.

An effective amount varies depending upon the health and physical condition of the subject to be treated, the taxonomic group of subjects to be treated (e.g. human, nonhuman primate, etc.), the capacity of the subject's nervous system, the degree of protection desired, the treating doctor's assessment of the medical situation, the condition to be treated or prevented, and other relevant factors.

Throughout this disclosure, various aspects of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

### Compositions of the Invention

In one aspect, the invention relates to a medical food comprising macronutrients and micronutrients. In one embodiment, the macronutrients are selected from the group consisting of proteins, sugars, and fats. In another embodiment, the macronutrients are selected from the group consisting of casein, sucrose, corn starch, and corn oil. In one embodiment, casein is low Cu and Fe casein. As one skilled in the art knows, casein refers chiefly to one or more related phosphoproteins commonly found in mammalian milk. As one skilled in the art knows, corn oil is a complex mixture comprising various amounts of saturated fatty acids, monounsaturated fatty acids, and polyunsaturated fatty acids.

In one embodiment, the medical food of the invention further comprises one or more vitamins selected from the group consisting of thiamin, riboflavin, pyridoxine, niacin, pantothenic acid and/or pantothenate, folic acid, biotin, vitamin B12, vitamin A, vitamin E, one or more tocopherols, vitamin D3 or cholecalciferol, vitamin K. In one embodiment, the pantothenate is calcium pantothenate. In another embodiment, the tocopherol is DL-alpha tocopheryl acetate. In another embodiment, vitamin K is an MSB complex. In one embodiment, the medical food of the invention includes all the vitamins recited herein.

In one embodiment, the medical food of the invention further comprises one or more elements, ions, or minerals, selected from the group consisting of calcium, phosphorus, potassium, sodium, chlorine, magnesium, copper, iron, zinc, manganese, iodine, and selenium. In one embodiment, the iron is present as ferric citrate. In one embodiment, the medical food of the invention has little to no iron. In another embodiment, the medical food of the invention has added iron. In one embodiment, the medical food of the invention includes all the elements, ions, or minerals recited herein, except iron. In one embodiment, the medical food of the invention includes all the elements, ions, or minerals recited herein.

In another embodiment, the medical food of the invention further comprises an amino acid. In one embodiment, the amino acid is selected from the group consisting of histidine, alanine, isoleucine, arginine, leucine, asparagine, lysine, aspartic acid, methionine, cysteine, phenylalanine, glutamic acid, threonine, glutamine, tryptophan, glycine, valine, pyrrolysine, proline, selenocysteine, serine, and tyrosine. In one embodiment, the amino acid is methionine. In one embodiment, the amino acid is DL-methionine.

In another embodiment, the medical food of the invention comprises choline. In one embodiment, choline is present as choline bitartrate.

In another embodiment, the medical food of the invention further comprises an antioxidant. In one embodiment, the antioxidant is selected from the group consisting of ethoxyquin, propyl gallate, octyl gallate, dodecyl gallate, butylated hydroxyanisole, butylated hydroxytoluene, tert-butylhydroquinone, and alpha-tocopherol. In one embodiment, the antioxidant is ethoxyquin.

### Formulations of the Invention

The medical food of the invention can be formulated in a wide range of forms and consistencies, wherein the compositions of the invention are incorporated in a wide range of amounts and concentrations. In one aspect, the medical food of the invention comprises a macronutrient selected from the group consisting of casein, sucrose, corn starch, and corn oil. In one embodiment, the concentration of casein in the medical food is from 5 to 500 g/Kg. In another embodiment, the concentration of casein in the medical food is from 50 to 350 g/Kg. In another embodiment, the concentration of casein in the medical food is from 100 to 250 g/Kg. In one embodiment, the concentration of casein in the medical food is about 200 g/Kg. In one embodiment, the concentration of sucrose in the medical food is from 50 to 750 g/Kg. In another embodiment, the concentration of sucrose in the medical food is from 100 to 650 g/Kg. In another embodiment, the concentration of sucrose in the medical food is from 250 to 550 g/Kg. In one embodiment, the concentration of sucrose in the medical food is about 548.815 g/Kg, excluding sucrose added as vehicle of additional ingredient(s), such as for example sucrose in a vitamin or mineral mix. In one embodiment, the concentration of corn starch in the medical food is from 25 to 500 g/Kg. In another embodiment, the concentration of corn starch in the medical food is from 50 to 350 g/Kg. In another embodiment, the concentration of corn starch in the medical food is from 100 to 250 g/Kg. In one embodiment, the concentration of corn starch in the medical food is about 150.0 g/Kg. In one embodiment, the concentration of corn oil in the medical food is from 5 to 250 g/Kg. In another embodiment, the concentration of corn oil in the medical food is from 10 to 150 g/Kg. In another embodiment, the concentration of corn oil in the medical food is from 25 to 100 g/Kg. In one embodiment, the concentration of corn oil in the medical food is about 50.0 g/Kg.

In one aspect, the medical food of the invention comprises an amino acid. In one embodiment, the amino acid is DL-Methionine, in a concentration from 0.5 to 10 g/Kg. In another embodiment, the concentration of DL-methionine in the medical food is from 1 to 7.5 g/Kg. In another embodiment, the concentration of DL-methionine in the medical food is from 2 to 5 g/Kg. In one embodiment, the concentration of DL-methionine in the medical food is about 3.0 g/Kg.

In one aspect, the medical food of the invention comprises a vitamin mix, in a concentration from 1 to 25 g/Kg. In another embodiment, the concentration of vitamin mix in the medical food is from 2.5 to 15 g/kg. In another embodiment, the concentration of vitamin mix in the medical food is from 5 to 12.5 g/Kg. In one embodiment, the concentration of vitamin mix in the medical food is about 10.0 g/Kg.

In one aspect, the medical food of the invention comprises a vitamin mix, further comprising one or more vitamins selected from the group consisting of thiamin HCl in a concentration from 0.1 to 3.0 g/Kg, riboflavin in a concentration from 0.1 to 3.0 g/Kg, pyridoxine HCl in a concentration from 0.1 to 3.5 g/Kg, niacin in a concentration from 0.5 to 15 g/Kg, calcium pantothenate in a concentration from 0.2 to 10 g/Kg, folic acid in a concentration from 0.05 to 1.5 g/Kg, biotin in a concentration from 0.005 to 0.2 g/Kg, vitamin B12 (about 0.1% in a vehicle, for example mannitol) in a concentration from 0.2 to 5 g/Kg, vitamin A (for example as an ester, in one embodiment, being palmitate; 500,000 IU/g) in a concentration from 0.1 to 5 g/Kg, vitamin E (for example as an ester, in one embodiment being DL-alpha tocopheryl acetate; 500 IU/g) in a concentration from 1 to 50 g/Kg, vitamin D3 (for example as cholecalciferol, about 400,000 IU/g in a vehicle, for example sucrose) in a concentration from 0.05 to 1.5 g/Kg, and vitamin K (as a complex, for example MSB complex) in a concentration from 0.02 to 1.5 g/Kg. In one embodiment, the balance of the vitamin complex to 1000 g/Kg is a vehicle, such as for example fine ground sucrose. In one embodiment, the vitamin mix includes all the vitamins recited herein.

In one embodiment, the concentration of thiamin HCl in the vitamin mix comprised by the medical food of the invention is about 0.6 g/Kg. In one embodiment, the concentration of riboflavin in the vitamin mix comprised by the medical food of the invention is about 0.6 g/Kg. In one embodiment, the concentration of pyridoxine HCl in the vitamin mix comprised by the medical food of the invention is about 0.7 g/Kg. In one embodiment, the concentration of niacin in the vitamin mix comprised by the medical food of the invention is about 3.0 g/Kg. In one embodiment, the concentration of calcium pantothenate in the vitamin mix comprised by the medical food of the invention is about 1.6 g/Kg. In one embodiment, the concentration of folic acid in the vitamin mix comprised by the medical food of the invention is about 0.2 g/Kg. In one embodiment, the concentration of biotin in the vitamin mix comprised by the medical food of the invention is about 0.02 g/Kg. In one embodiment, the concentration of vitamin B12 (about 0.1% in a vehicle, for example mannitol) in the vitamin mix comprised by the medical food of the invention is about 1.0 g/Kg. In one embodiment, the concentration of vitamin A (for example as an ester, in one embodiment being palmitate; 500,000 IU/g) in the vitamin mix comprised by the medical food of the invention is about 0.8 g/Kg. In one embodiment, the concentration of vitamin E (for example as an ester, in one embodiment being DL-alpha tocopheryl acetate; 500 IU/g) in the vitamin mix comprised by the medical food of the invention is about 10.0 g/Kg. In one embodiment, the concentration of vitamin D3 (for example as cholecalciferol, about 400,000 IU/g in a vehicle, for example sucrose) in the vitamin mix comprised by the medical food of the invention is about 0.25 g/Kg. In one embodiment, the concentration of vitamin K (as a complex, for example MSB complex) in the vitamin mix comprised by the medical food of the invention is about 0.15 g/Kg. In one embodiment, the concentration of the balance vehicle, for example fine ground sucrose, in the vitamin mix comprised by the medical food of the invention is about 981.08 g/Kg.

In one aspect, the medical food of the invention comprises a mineral mix, in a concentration from 5 to 50 g/Kg. In another embodiment, the concentration of mineral mix in the medical food is from 10 to 45 g/kg. In another embodiment, the concentration of mineral mix in the medical food is from 15 to 40 g/Kg. In one embodiment, the concentration of mineral mix in the medical food is about 35 g/Kg.

In one aspect, the medical food of the invention comprises one or more elements, ions, or minerals, selected from the group consisting of calcium in a concentration from 1 to 50 g/kg, phosphorus in a concentration from 1 to 25 g/kg, potassium in a concentration from 1 to 30 g/kg, sodium in a concentration from 0.1 to 10 g/kg, chlorine in a concentration from 0.25 to 25 g/kg, magnesium in a concentration from 0.1 to 10 g/kg, copper in a concentration from 1 to 65 mg/kg, iron in a concentration from 0 to 1000 mg/kg, zinc in a concentration from 5 to 350 mg/kg, manganese in a concentration from 10 to 500 mg/kg, iodine in a concentration from 0.01 to 50 mg/kg, and selenium in a concentration from 0.01 to 1 mg/kg. In one embodiment, the mineral mix includes all the elements, ions, or minerals recited herein.

In certain embodiments, the concentration of calcium in the medical food of the invention is about 5.20 g/Kg, or about 10.0 g/kg. In certain embodiments, the concentration of phosphorus in the medical food of the invention is about 5.39 g/Kg, or about 4.0 g/kg. In certain embodiments, the concentration of potassium in the medical food of the invention is about 3.60 g/Kg, or about 6.0 g/kg. In certain embodiments, the concentration of sodium in the medical food of the invention is about 1.02 g/Kg, or about 2.0 g/kg. In certain embodiments, the concentration of chlorine in the medical food of the invention is about 1.57 g/Kg, or about 4.0 g/kg. In certain embodiments, the concentration of magnesium in the medical food of the invention is about 0.51 g/Kg, or about 2.0 g/kg. In certain embodiments, the concentration of copper in the medical food of the invention is about 5.81 mg/Kg, or about 15.0 mg/kg. In certain embodiments, the concentration of iron in the medical food of the invention is about 0.00 mg/kg, from 2 to 6 mg/Kg, about 40.42 mg/Kg, about 202.10 mg/Kg, or about 200.0 mg/Kg. In certain embodiments, the concentration of zinc in the medical food of the invention is about 34.50 mg/Kg, or about 70.0 mg/kg. In certain embodiments, the concentration of manganese in the medical food of the invention is about 58.54 mg/Kg, or about 100.0 mg/kg. In certain embodiments, the concentration of iodine in the medical food of the invention is about 0.21 mg/Kg, or about 6.0 mg/kg. In certain embodiments, the concentration of selenium in the medical food of the invention is about 0.11 mg/Kg, or about 0.2 mg/kg.

In one aspect, the medical food of the invention comprises iron in the form of ferric citrate, in a concentration from 0.1 to 10 g/Kg. In one embodiment, the concentration of ferric citrate in the medical food of the invention is from 0.25 to 5 g/Kg. In another embodiment, the concentration of ferric citrate in the medical food of the invention is from 0.5 to 2.5 g/Kg. In one embodiment, the concentration of ferric citrate in the medical food of the invention is about 1.175 g/Kg.

In one aspect, the medical food of the invention comprises choline, for example as choline bitartrate, in a concentration from 0.25 to 10 g/Kg. In one embodiment, the concentration of choline bitartrate in the medical food of the invention is from 0.5 to 5 g/Kg. In another embodiment, the concentration of choline bitartrate in the medical food of the invention is from 1 to 2.5 g/Kg. In one embodiment, the concentration of choline bitartrate in the medical food of the invention is about 2.0 g/Kg.

In one aspect, the medical food of the invention comprises an antioxidant, for example ethoxyquin, in a concentration from 0.002 to 0.1 g/Kg. In one embodiment, the concentration of ethoxyquin in the medical food of the invention is from 0.005 to 0.05 g/Kg. In one embodiment, the concentration of ethoxyquin in the medical food of the invention is about 0.01 g/Kg.

The nutraceutical medical food formulations for use in accordance with the present invention can be formulated in a conventional manner using one or more physiologically acceptable carriers or excipients. Agents used in the formulations and their physiologically acceptable salts and solvates can be prepared for administration by various methods. In an exemplary embodiment, administration of the solid or liquid formulations is oral. In an alternative embodiment, administration is parenteral, e.g., intravenous, subcutaneous, intramuscular, intracranial, intraorbital, ophthalmic, intraventricular, intracapsular, intraspinal, intracistemal, intraperitoneal, or transmucosal. The compositions can be formulated in various ways, according to the route of administration.

For oral administration, the formulations can take the form of, for example, tablets, capsules, or bars, prepared by conventional means with pharmaceutically acceptable excipients such as binding agents (for example, pregelatinised maize starch, polyvinylpyrrolidone or hydroxypropyl methylcellulose); fillers (for example, lactose, microcrystalline cellulose or calcium hydrogen phosphate); lubricants (for example, magnesium stearate, talc or silica); disintegrants (for example, potato starch or sodium starch glycolate); or wetting agents (for example, sodium lauryl sulphate). The tablets can be coated by methods well known in the art. Also included are bars and other chewable formulations.

In various embodiments, the medical food compositions of the present invention may also be formulated as liquid suspensions. Liquid suspensions may be prepared using conventional methods to achieve suspension of the compositions described herein in an aqueous or oily vehicle. Aqueous vehicles include, for example, water and isotonic saline. Oily vehicles include, for example, almond oil, oily esters, ethyl alcohol, vegetable oils such as arachis, olive, sesame, or coconut oil, fractionated vegetable oils, and mineral oils such as liquid paraffin. Liquid suspensions may further comprise one or more additional ingredients including, but not limited to, suspending agents, dispersing or wetting agents, emulsifying agents, demulcents, preservatives, buffers, salts, flavorings, coloring agents, and sweetening agents. Oily suspensions may further comprise a thickening agent. Known suspending agents include, but are not limited to, sorbitol syrup, hydrogenated edible fats, sodium alginate, polyvinylpyrrolidone, gum tragacanth, gum acacia, and cellulose derivatives such as sodium carboxymethylcellulose, methylcellulose, and hydroxypropyl methylcellulose. Known dispersing or wetting agents include, but are not limited to, naturally occurring phosphatides such as lecithin, condensation products of an alkylene oxide with a fatty acid, with a long chain aliphatic alcohol, with a partial ester derived from a fatty acid and a hexitol, or with a partial ester derived from a fatty acid and a hexitol anhydride (e.g., polyoxyethylene stearate, heptadecaethyleneoxycetanol, polyoxyethylene sorbitol monooleate, and polyoxyethylene sorbitan monooleate, respectively). Known emulsifying agents include, but are not limited to, lecithin and acacia. Known preservatives include, but are not limited to, methyl, ethyl, or n-propyl para-hydroxybenzoates, ascorbic acid, and sorbic acid. Known sweetening agents include, for example, glycerol, propylene glycol, sorbitol, sucrose, and saccharin. Known thickening agents for oily suspensions include, for example, beeswax, hard paraffin, and cetyl alcohol.

Liquid preparations for oral administration can also take the form of, for example, solutions, syrups or suspensions, or they can be presented as a dry product for constitution with water or other suitable vehicle before use. In one embodiment, the liquid preparations can be formulated for administration with fruit juice, for example apple juice. Such liquid preparations can be prepared by conventional means with pharmaceutically acceptable additives such as suspending agents (for example, sorbitol syrup, cellulose derivatives or hydrogenated edible fats); emulsifying agents (for example, lecithin or acacia); non-aqueous vehicles (for example, almond oil, oily esters, ethyl alcohol or fractionated vegetable oils); and preservatives (for example, methyl or propyl-p-hydroxybenzoates or sorbic acid). Other suitable non-aqueous vehicles may include neuroprotective foods, e.g., fish oil, flax seed oil, etc. The preparations can also contain buffer salts, flavoring, coloring and sweetening agents as appropriate.

Preparations and formulations for oral administration may be provided as a unit dosage form, for example, as tablets, capsules, or bars. These can be presented in blister packs or in multi-dose containers. Preparations for oral administration can also be suitably formulated to give controlled release of any or all active compounds.

For buccal or sublingual administration the formulations can take the form of tablets or lozenges formulated in conventional manner. The formulations can be prepared for parenteral administration by injection, for example, by bolus injection or continuous infusion. Formulations for injection can be presented in unit dosage form, for example, in ampoules or in multi-dose containers, with an added preservative. The formulations can take such forms as suspensions, solutions or emulsions in oily or aqueous vehicles, and can contain formulatory agents such as suspending, stabilizing and/or dispersing agents. Alternatively, the active ingredients and compositions can be in powder form for constitution with a suitable vehicle, for example, sterile pyrogen-free water, before use.

The formulations can also be prepared in rectal compositions such as suppositories or retention enemas, for example, containing conventional suppository bases such as cocoa butter or other glycerides.

The formulations can also be provided as a depot preparation. Such long acting formulations may be administered by implantation (for example subcutaneously or intramuscularly) or by intramuscular injection. Thus, for example, the formulations can be prepared with suitable polymeric or hydrophobic materials (for example as an emulsion in an acceptable oil) or ion exchange resins, or as sparingly soluble derivatives, for example, as a sparingly soluble salt.

The formulations can be presented in a pack or dispenser device, which may contain one or more unit dosage forms containing any or all of the ingredients described herein. The pack may, for example, comprise metal or plastic foil, such as a blister pack. The pack or dispenser device can be accompanied by instructions for administration.

The medical food formulations of the invention can also contain one or more carriers or excipients, many of which are known to skilled artisans. Excipients that can be used include buffers (for example, citrate buffer, phosphate buffer, acetate buffer, and bicarbonate buffer), amino acids, urea, alcohols, ascorbic acid, phospholipids, proteins (for example, serum albumin), EDTA, sodium chloride, liposomes, mannitol, sorbitol, and glycerol.

In one aspect, the invention also relates to a nutritional medical food formula formulated to provide a nutritional product that can be the sole source of nutrition for patients or subjects consuming it. To provide effective nutrition to human infants, children and adults, the medical food of the invention considers in one embodiment the bioavailability of trace and ultratrace minerals and the dietary interactions involving trace elements (Forbes et al., 1983, Ann. Rev. Nutr., 3:213-231; Mills, 1985, Ann. Rev. Nutr., 5:173-193). As described in U.S. Pat. Nos. 5,326,569 and 5,550,146 incorporated herein in their entirety by reference, a mixture rich in fats, carbohydrates, vitamins, minerals and trace elements can be used as a generic powder base. In one embodiment, the powder base is admixed with all or most of the macronutrients, vitamins, and minerals described herein, including or excluding an iron source, to yield therapeutic medical food products that are used in the nutritional support of adults and children having, or at risk of having malaria, the symptoms of cerebral malaria, and/or iron deficiency.

Methods useful for making formulations are known in the art and can be found in, for example, Remington's Pharmaceutical Sciences (Gennaro, ed., Williams & Wilkins, Baltimore, Md.).

### Methods of Treatment and Prevention

The present invention is based, at least in part, on the unexpected discovery of novel nutraceutical medical food formulations which prevent the severity of symptoms associated with malaria, in particular with cerebral malaria (CM). The present invention is further based, at least in part, on the unexpected discovery of novel nutraceutical medical food formulations which in addition to preventing the severity of symptoms associated with malaria or CM, are also preventing the negative consequences of iron deficiency, improving as a result the long term outcome for children or other populations at risk from iron deficiency. The development of non-prescription nutraceutical medical food formulations is highly desirable as both a preventative measure, both as to malaria and iron deficiency, as well as to augment any pharmacological treatment approaches to either malaria, cerebral malaria or iron deficiency. Such nutraceutical medical food formulations are useful for both diseased and normal subjects, e.g., normal children or adults seeking to prevent onset of either malaria or iron deficiency, and/or seeking to augment their caloric intake.

Malaria is, generally, a disease caused by a parasite, and is one of the most known mosquito-borne diseases. Plasmodium falciparum is the most abundant and dangerous causative species, largely resistant to the majority of currently available anti-malarial drugs. One of the most severe complications of P. falciparum infection is cerebral malaria (CM), which is expressed in about 7 percent of P. falciparum malaria cases. CM manifests as coma (Blantyre coma scale <2 or Glasgow coma scale <8), P. falciparum on blood smear, and no other known cause for coma (John et al., 2008, Pediatrics, 122:e92-e99). CM affects an estimated 785,000 children in sub-Saharan Africa every year, with an average mortality rate of 18.6 percent, and one in four children who survive CM suffer long-term cognitive impairment (John et al., 2008, Pediatrics, 122:e92-e99). Although the pathogenesis of CM is unclear, a simplified explanation is that the adherence “to endothelial cells and the sequestration of parasitized erythrocytes and immune cells in brain capillaries cause an inflammatory process and the release of other neurotoxic molecules” (Golenser, et al., 2006, Int. J. Parasitology, 36:583-593). It is possible to treat some CM cases with anti-malaria drugs, but there is an “irreversible stage after which the patient dies, despite massive anti-parasitic treatment” (Golenser, et al., 2006, Int. J. Parasitology, 36:583-593).

Iron deficiency (ID) is the most prevalent single deficiency state on a worldwide basis. It is important economically because it diminishes the capability of individuals who are affected to perform physical labor, and it diminishes both growth and learning in children. Absolute iron deficiency, with anemia or without anemia, and functional iron deficiency (FID) are high frequency clinical conditions, and these patients have iron deficient erythropoiesis. Absolute iron deficiency is defined as a decreased total iron body content. Iron deficiency anemia (IDA) occurs when iron deficiency is sufficiently severe to diminish erythropoiesis and cause the development of anemia.

Iron status can be measured using hematological and biochemical indices. Each parameter of iron status reflects changes in different body iron compartments and is affected at different levels of iron depletion. Specific iron measurements include hemoglobin (Hgb), mean cell volume (MCV), hematocrit (Hct), erythrocyte protoporphyrin, plasma iron, transferrin, transferrin saturation levels (TSAT), serum ferritin (SF) and more recently soluble transferrin receptors (sTfR) and red-cell distribution width (RDW). Hemoglobin (Hgb) has been used longer than any other iron status parameter. It provides a quantitative measure of the severity of iron deficiency once anemia has developed. Hemoglobin determination is a convenient and simple screening method and is especially useful when the prevalence of iron deficiency is high, as in pregnancy or infancy.

Iron supplementation in patients in need thereof, but which are also afflicted with malaria, was traditionally controversial because of concerns that it may increase the severity of the infection. Support for this proposition was found for example in the past in studies which shown that individuals with iron deficiency are less susceptible to infections, and that in ECM animal models iron deficiency is associated with increased survival and decreased parasitemia. But to the contrary, iron supplements given to iron deficient (ID) children infected with P. falciparum were more recently shown to improve the outcome after malaria infection, and as a result the World Health Organization (WHO) currently recommends that iron supplements be given while a person's malaria status is monitored or while they are under treatment.

In one aspect, the invention relates to a method of treating or preventing malaria by administering to a subject in need thereof an effective amount of a formulation of the invention. In another aspect, the invention relates to a method of treating or preventing the symptoms of a malaria related disorder, for example cerebral malaria, by administering to a subject in need thereof an effective amount of a formulation of the invention. The nutraceutical medical food formulations described herein contain components that synergistically provide protection against the undesirable symptoms of malaria in general, and cerebral malaria in particular, and promote survival and minimize damage associated with ECM. In another aspect, the invention relates to a method of treating or preventing the symptoms of malaria or cerebral malaria, and of treating or preventing iron deficiency, by administering to a subject in need thereof an effective amount of a formulation of the invention comprising at least one form of iron.

In one aspect, administration of the medical food of the invention delays parasitemia and improves survival in subjects receiving it. In one embodiment, administration of the medical food of the invention to subjects in a population, increases the survival rates thereof compared to a control population. In one embodiment, the survival rate is increased until at least day 14 post infection. In another embodiment, the survival rate in the subject population is about 80%. In another embodiment, the survival rate in the subject population is about 100%. In one embodiment, administration of the medical food of the invention limits access of Sema4A to the brain, which one skilled in the art knows to be cytotoxic to oligodendrocytes. In another embodiment, administration of the medical food of the invention increases Epo. In another embodiment, administration of the medical food of the invention maintains lower levels of IL-6. In one embodiment, administration of the medical food of the invention maintains normal iron levels and limits the neurological effects from malarial infection.

In one aspect, the invention relates to administering the formulations of the invention alone. In another aspect, the invention relates to administering the formulations of the invention together in combination with other nutraceutical or pharmaceutical compositions. Nutraceutical or pharmaceutical compositions suitable for administration in combination with the formulations of the invention include nutraceutical or pharmaceutical compositions effective in treating malaria, improving or preventing the symptoms of cerebral malaria, and treating iron deficiency. The compositions of the invention may be administered to any mammal, including for example a mouse, including mouse models for malaria and cerebral malaria, or a human.

In certain embodiments the medical food of the invention may contain, or be administered in combination with antimalarial agents such as for example selected from, but not limited to, ailanthone, 8-aminoquinoline, amodiaquine, aplasmomycin, artelinic acid, artemether, artemether/lumefantrine, artemisinin, artemotil, arterolane, artesunate, artesunate/amodiaquine, artesunate plus sulfadoxine-pyrimethamine, atovaquone, atovaquone/proguanil, azithromycin, chloroquine, chlorproguanil, chlorproguanil/dapsone, chlorproguanil hydrochloride-dapsone-artesunate, cinchona, codinaeopsin, cotrifazid, cryptolepine, cycloguanil, dihydroartemisinin, doxycycline, ELQ-300, halofantrine, hydroxychloroquine, Jesuit's bark, lumefantrine, mefloquine, mepacrine, neurolenin B, cipargamin, nitidine, olivacine, oroidin, pamaquine, piperaquine, primaquine, proguanil, pyrimethamine, pyronaridine, quinine, semapimod, spiroindolone, sulfadoxine, sulfadoxine/pyrimethamine, sulfalene, tafenoquine, and Warburg's tincture.

In some preferred embodiments, the formulation of the invention is administered orally. In an alternative embodiment, the formulation is administered parenterally. In a further embodiment of these aspects, the formulation is administered as a unit dosage form.

Importantly, in one embodiment of the invention, the combination of components of the formulations have been discovered to be more effective than the individual components in the uses of the invention. As the results described herein indicate, the degree of efficacy of the particular formulations of the invention was completely unanticipated, indicating that these unique combinations synergistically provide neuro- and hemato-protection. Although convenient for administration, it is not necessary for the agents or components of the nutraceutical formulations to be compounded together for administration to a subject. Instead, they can be administered concurrently, or in close enough succession so that the desired dosage level for all components is achieved in the bloodstream at the same time.

In general, a nutraceutical medical food formulation is formulated by combining appropriate concentrations of stock agent (e.g., in solution or solid) of the components in a medium. The components can be administered together, in rapid succession, or at intervals. A composition may be tested to determine whether it is an effective nutraceutical medical food formulation in an in vitro cell culture system of primary, secondary, or immortalized neural cells, for example, cells that exhibit the molecular and biochemical characteristics of normal neural cells, or cells that exhibit at least some of the molecular and biochemical characteristics of a neurologic disorder. Such cells and methods of evaluating the effects of the formulations are known in the art. Biochemical and physical criteria can be used to measure the ability of a nutraceutical medical food formulation to ameliorate adverse events associated with cerebral malaria and iron deficiency. Biochemical and physical criteria can additionally be used to measure the ability of a nutraceutical medical food formulation to ameliorate adverse effects associated with a disorder.

Animal models are likewise useful for evaluating the efficacy of a nutraceutical medical food formulation. Nutraceutical medical food formulations can be evaluated in vivo using an animal model, for example, an animal model for cerebral malaria (CM), and/or iron deficiency (ID). Examples of animal models for CM are mice infected with a malaria parasite. Examples of animal models for ID are H67D knock-in mice. The effects of a nutraceutical medical food formulation on ameliorating malaria, CM, and/or ID symptoms in such mice are evaluated after administering a nutraceutical medical food formulation to these mice both early in life and after symptoms begin to develop. Mice are evaluated for parasitemia, hematological parameters such as hematocrit, and various neurological parameters, such as blood brain barrier (BBB) break down, neuronal damage, and myelin disruption. Prevention of the onset or progression of symptoms, or amelioration of existing symptoms, indicates that the nutraceutical medical food formulation is effective for treating and preventing malaria, CM, and/or ID.

While is not necessary for all of the components of a nutraceutical medical food formulation to be administered in the same excipient, in the same form, or delivered at precisely the same time during a day, the components could be administered so they are present in the treated subject at the same time, for example present in a cell, tissue, or organ that is the target of treatment, and thus, one formulation, including all and/or most of the components is generally provided in a convenient dosage form.

The nutraceutical medical food formulations of the invention may be components in kits. These kits can also include instructions for administration of the formulations to a subject, and optionally may include one or more other nutraceuticals, medical foods, or pharmaceutical compositions, e.g., ginkgo biloba, fish oil, apple juice, flax seed oil, and other nutraceutical medical foods or antimalarial drug formulations known in the art.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teachings provided herein.

Without further description, it is believed that one of ordinary skill in the art can, using the preceding description and the following illustrative examples, make and utilize the compounds of the present invention and practice the claimed methods. The following working examples therefore, specifically point out the preferred embodiments of the present invention, and are not to be construed as limiting in any way the remainder of the disclosure.

### Example 1: Medical Diet as a Preventive Supplement for Cerebral Malaria

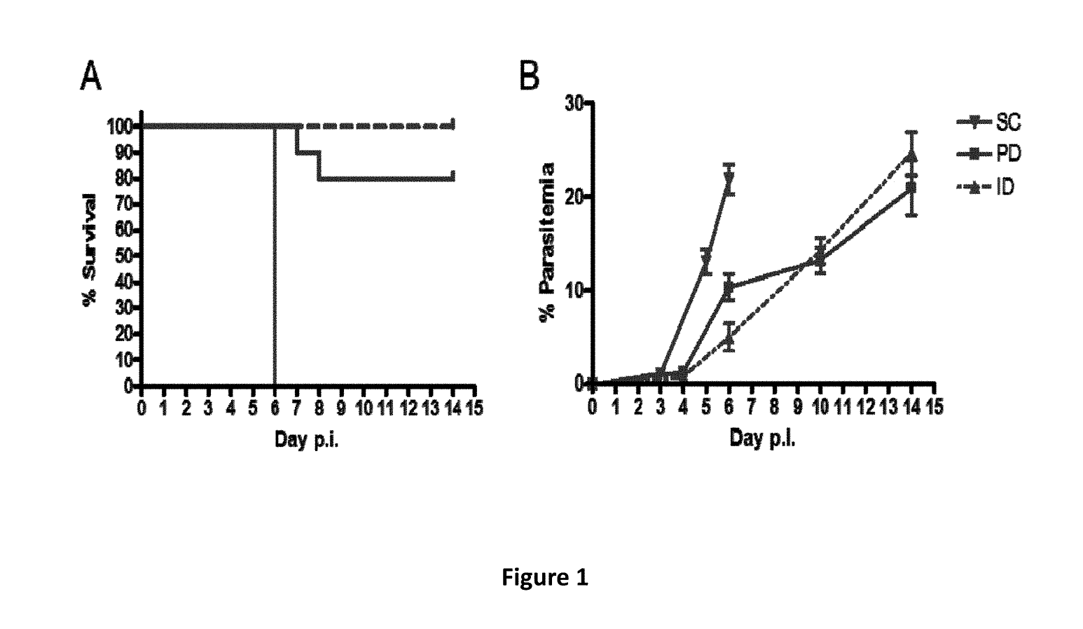

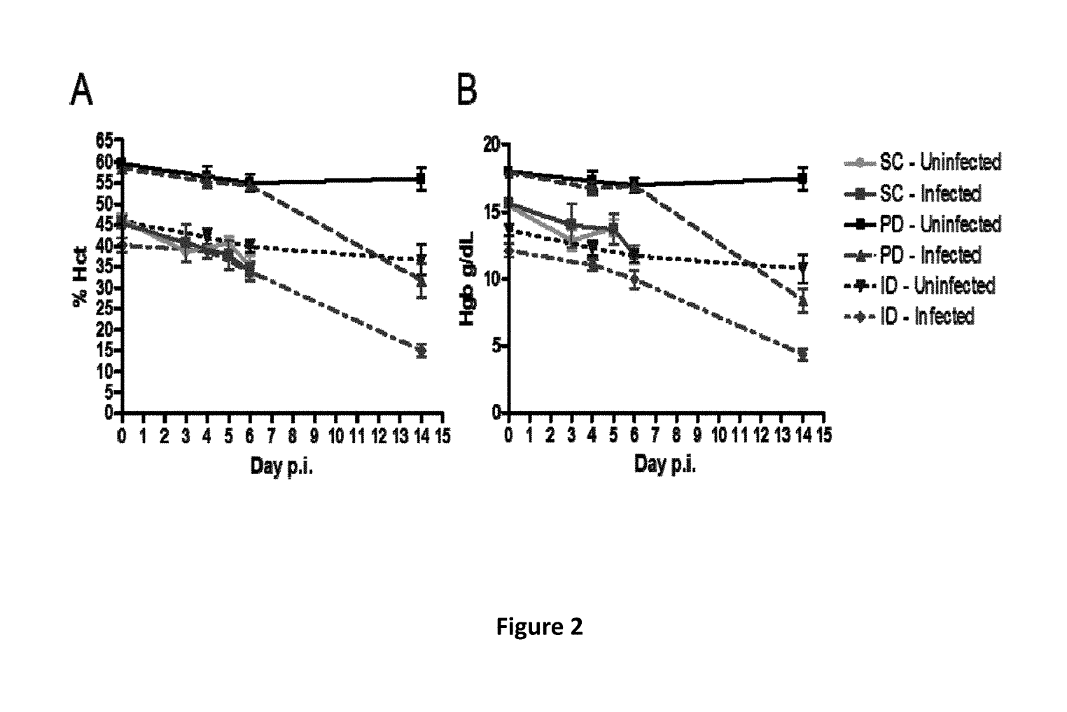

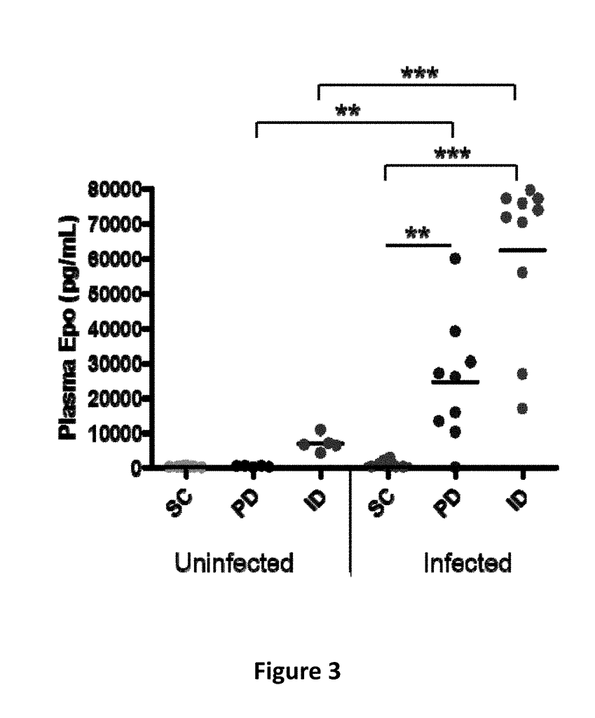

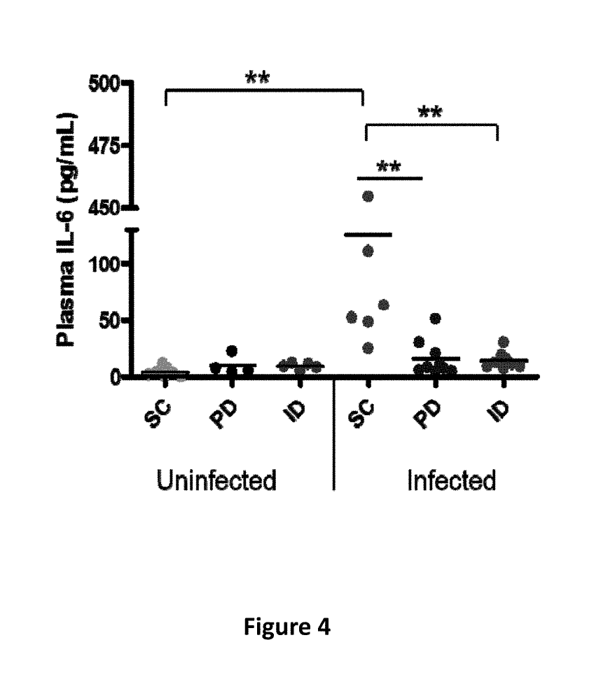

The invention relates to an animal model of cerebral malaria (CM) using five week old, C57BL/6 mice infected with Plasmodium berghei ANKA. While the pathogenesis of CM is not completely understood, it is reported that following peripheral inflammation there is cerebral inflammation with astrogliosis and microgliosis, blood brain barrier (BBB) break down, neuronal damage, and myelin disruption. These pathological findings occur in both human patients and in the mouse model. In the mouse model, infected mice show neurological symptoms and are moribund between days 6-8 post infection (p.i.). In the working model described herein, the medical diet was evaluated in two forms, in a diet supplemented with normal levels of iron (200 ppm) and in a diet with low levels of iron (4 ppm). The iron deficient diet was included as a known protective model for comparison to the preventative diet. Mice were put on these diets for two weeks before infection, starting at three weeks of age. For comparison to the standard model of CM, there were included mice on standard rodent chow. The survival rate was increased until at least day 14 p.i. for the preventative diet (80% survival) and for low levels of iron (100% survival) (FIG. 1A). Mice on the standard rodent chow were moribund by day 6 p.i. There was no significant difference in survival between mice on the preventative diet and mice on the iron deficient diet. Therefore, the normal levels of iron in the preventative diet did not adversely affect the disease while maintaining a normal hemoglobin (Hgb) and hematocrit (Hct). Parasitemia was slightly but significantly higher on day 6 p.i. for mice on the preventative diet but after that point was no different from the animals on the iron deficient diet. The animals on the standard rodent chow had parasitemia levels that were two-fold higher than the preventative diet group on day 6 p.i. (FIG. 1B). Throughout the course of the study, there were also monitored hematological parameters and erythropoietin (Epo) levels because they may be impacted by changes in iron and by infection. Hematological parameters (including Hct and Hgb) were elevated in mice on the preventative diet containing normal iron levels when compared to the low iron diet and standard rodent chow (FIG. 2). Epo levels were evaluated when mice where moribund or at the end of the study in survivors, which were found to be elevated in both the preventative and iron deficient diet groups. The Epo levels correlated with longer survival (FIG. 3). Elevated Epo levels are known to be beneficial in CM and are even considered a treatment option but are too expensive to be useful for the general at risk population. The malarial infection induces a robust inflammatory reaction. IL-6 levels were measured, which are reported to increase after malaria infection, and were found at uninfected control levels in mice on the preventative and iron deficient diets; except in the 2 mice on the preventative diet that died (FIG. 4).

In summary, the preventative diet with normal iron levels increased survival and maintained hematological parameters at normal levels in the beginning of infection while increasing Epo and attenuating IL-6. Overall, this diet improved the outcome of infected mice. This medical diet will prevent the severity of symptoms associated with CM and the negative consequences of iron deficiency and improve the long term outcome for children.

### Vitamin Mix AIN-76A

| | | |
|---|---|---|
| Thiamin HCl | 0.6 | g/Kg |
| Riboflavin | 0.6 | g/Kg |
| Pyridoxine HCl | 0.7 | g/Kg |
| Niacin | 3.0 | g/Kg |
| Calcium Pantothenate | 1.6 | g/Kg |
| Folic Acid | 0.2 | g/Kg |
| Biotin | 0.02 | g/Kg |
| Vitamin B12 (0.1% in mannitol) | 1.0 | g/Kg |
| Vitamin A Palmitate (500,000 IU/g) | 0.8 | g/Kg |
| Vitamin E, DL-alpha tocopheryl acetate (500 IU/g) | 10.0 | g/Kg |
| Vitamin D3, cholecalciferol (400,000 IU/g in sucrose) | 0.25 | g/Kg |
| Vitamin K, MSB complex | 0.15 | g/Kg |
| Sucrose, fine ground | 981.08 | g/Kg |

### Calculated Minerals Levels in Fe Adjusted Rodent Diet Series

### TD.80396: IRON DEFICIENT DIET

### TD.89300: ADJUSTED IRON DIET (40)

### TD.130369: 200 ppm Fe Rodent Diet (Fe Citrate)

### 2018: Standard Diet

| Minerals | TD.80396 | TD.89300 | TD.130369 | 2018 |
|---|---|---|---|---|
| Calcium g/kg | 5.20 | 5.20 | 5.20 | 10.0 |
| Phosphorus g/kg | 5.39 | 5.39 | 5.39 | 4.0 |
| Potassium g/kg | 3.60 | 3.60 | 3.60 | 6.0 |
| Sodium g/kg | 1.02 | 1.02 | 1.02 | 2.0 |
| Chlorine g/kg | 1.57 | 1.57 | 1.57 | 4.0 |
| Magnesium g/kg | 0.51 | 0.51 | 0.51 | 2.0 |
| Copper mg/kg | 5.81 | 5.81 | 5.81 | 15.0 |
| Iron mg/kg | 0.00 | 40.42 | 202.10 | 200.0 |
| Zinc mg/kg | 34.50 | 34.50 | 34.50 | 70.0 |
| Manganese mg/kg | 58.54 | 58.54 | 58.54 | 100.0 |
| Iodine mg/kg | 0.21 | 0.21 | 0.21 | 6.0 |
| Selenium mg/kg | 0.11 | 0.11 | 0.11 | 0.2 |

Values are calculated from data of included ingredients. Actual values of any given batch of diet may vary slightly.

### 200 ppm Fe Rodent Diet (Fe Citrate)

| | | |
|---|---|---|
| Casein, low Cu & Fe | 200.0 | g/Kg |
| DL-Methionine | 3.0 | g/Kg |
| Sucrose | 548.815 | g/Kg |
| Corn Starch | 150.0 | g/Kg |
| Corn Oil | 50.0 | g/Kg |
| Mineral Mix, Fe Deficient (81062) | 35.0 | g/Kg |
| Ferric Citrate | 1.175 | g/Kg |
| Vitamin Mix, AIN-76A (40077) | 10.0 | g/Kg |
| Choline Bitartrate | 2.0 | g/Kg |
| Ethoxyquin, antioxidant | 0.01 | g/Kg |

### Iron Deficient Diet

| Formula | g/Kg |
|---|---|
| Casein, low Cu & Fe | 200.0 |
| DL-Methionine | 3.0 |
| Sucrose | 549.99 |
| Corn Starch | 150.0 |
| Corn Oil | 50.0 |
| Mineral Mix, Fe Deficient (81062) | 35.0 |
| Vitamin Mix, AIN-76A (40077) | 10.0 |
| Choline Bitartrate | 2.0 |
| Ethoxyquin, antioxidant | 0.01 |

### Example 2: HFE Genotype and a Formulated Diet Controlling for Iron Status Attenuate Cerebral Malaria in Mice

To further evaluate the impact of iron status during ECM, genetically modified mice carrying the H67D mutation of HFE (High Fe) in a mixed C57BL/6/129/Sv background were infected with the P. berghei ANKA strain. This allele is the mouse equivalent of the human H63D HFE allele which is common in humans, especially Caucasians where it occurs in as many as 15% of the population (Merryweather-Clarke et al., 2000, Genet Test, 4:183-198). The gene variant results in a mutant HFE protein that reduces the ability to detect and modulate iron status (Ehrlich et al., 2000, Immunity, 13:585-588). In addition to playing a role in iron homeostasis, HFE is a non-classical MHC-1 (major histocompatibility)-like protein that interacts with 132 microglobulin. It does not, however, function as an antigen presenting molecule or play a role in normal cytokine production by macrophages and T cells (Arosa et al., 1994, Scand J Immunol, 39:426-432; Porto et al., 1994, Eur J Haematol, 52:283-290; Feder et al., 1996, Nat Genet, 13:399-408; Lebrón et al., 1998, Cell, 93:111-123; Cardoso et al., 2003, Tissue Antigens, 61:263-275; Wang et al., 2008, J Immunol, 181:2723-2731; Wang et al., 2009, J Clin Invest, 119:3322-3328). A mutation in HFE can influence the inflammatory response both directly through its interaction with the immune system and indirectly through modifying the cellular iron response (van Asbeck et al., 1982, Br Med J (Clin Res Ed), 284:542-544; van Asbeck et al., 1984, J Infect, 8:232-240; Moura et al., 1998, Eur J Clin Invest, 28:164-173; Wang et al., 2008, J Immunol, 181:2723-2731; Wang et al., 2009, J Clin Invest, 119:3322-3328).

The H67D animal model, similar to the human condition associated with the HFE variant, has increased liver (Tomatsu et al., 2003, Proc Natl Acad Sci USA, 100:15788-15793) and brain iron (Nandar et al., 2013, Biochim Biophys Acta, 1832:729-741). It was hypothesized that the H67D phenotype would lead to greater mortality during ECM if increased iron is responsible for more severe disease. This genotype model was compared with mice on formulation diets that were either ID or iron adequate. Young mice were used to better model the younger human population in which CM is more prevalent.

The materials and methods employed in these experiments are now described.

### Materials and Methods

Animal Experiments

Mice were infected i.p. with 10⁶ Plasmodium berghei (P. berghei) ANKA strain infected red blood cells (RBCs, a gift from Martha Siddiqi, Naval Medical Research Center, USA). Parasitemia levels were monitored by Giemsa-stained tail vein blood smears. Infected mice typically die within 1 week post infection (p.i.). Mice that did not show neurological sequelae and were not moribund were euthanized by 22 days p.i. Mice were maintained in accordance with the National Institutes of Health (NIH, USA) Guide for the Care and Use of Laboratory Animals and according to the Pennsylvania State University, USA, Institutional Animal Care and Use Committee (IACUC). Tail vein blood was used to measure hematocrit (Hct) and mean corpuscular volume (MCV), using a BC-2800 automated hematology analyzer (MindRay, Mahwah, N.J., USA).

Standard CM in WT Mice

For the standard model of ECM, 8-week-old female C57BL/6 mice (The Jackson Laboratory, USA) were infected and uninfected mice served as controls. Mice were maintained on standard rodent chow ad libitum (Harlan Teklad 2018, USA) and euthanized after showing severe neurological deficits (i.e. laying on their side and unable to right themselves). A total of 15 mice were used in two separate experiments.

ID Study

For the ID study, C57BL/6 mice (The Jackson Laboratory, USA) were weaned on post-natal day 21 onto specially prepared formulation diets containing either 200 ppm (normal iron content) or 4 ppm (ID diet) iron (Harlan Laboratories, Indianapolis, Ind., USA). Both pelleted diets were composed from the same base diet, which excluded extraneous sources of iron such as soluble fiber, cellulose, wheat, soy, etc. However all other mineral levels met American Institute of Nutrition (AIN) guidelines. After 2 weeks on the formulation diets (5 weeks of age), 10 mice were infected and five uninfected mice served as controls in each diet group. Due to the dramatic results associated with this dietary manipulation, the study was replicated two additional times with two other groups of animals comparing only the novel iron adequate formulation (n=15) versus standard rodent chow (n=15). The replication studies increased the overall sample size for the survival studies to 25 infected mice on the iron adequate diet and 15 mice on standard rodent chow.

HFE Study

H67D knock-in mice were generated on a mixed background of C57BL/6 and 129/Sv as previously described (Tomatsu et al., 2003, Proc Natl Acad Sci USA, 100:15788-15793). H67D and H67H (wild type) homozygous mice were crossed and tail clips from offspring mice were genotyped to confirm homozygosity for either H67H or H67D as previously described (Nandar et al., 2013, Biochim Biophys Acta, 1832:729-741). Seventeen homozygous H67H mice were used as controls for comparison with 12 homozygous H67D mice. Of these, eight H67H and six H67D mice were infected at 8 weeks of age. The remaining uninfected mice were followed as controls. All of these mice consumed standard rodent chow ad libitum.

Western Blots

Denaturing SDS-PAGE (BioRad, Hercules, Calif., USA) gels were used to separate 50 ug (brain homogenate) or 10 ug (myelin) of protein per lane. Proteins were transferred to nitrocellulose, which was blocked with 5% milk Tris-Buffered Saline Tween-20 (TBST). Whole brain homogenate from uninfected and infected mice was evaluated for transferrin receptor (TfR), H-ferritin (Hft), T cell immunoglobulin and mucin domain containing 2 (Tim2), CXCR4, Semaphorin 4A (Sema4A) protein expression, and actin for 16 h at 4° C. Anti-TfR (1:500, mouse monoclonal antibody) was purchased from Invitrogen (Carlsbad, Calif., USA). Anti-Hft (1:1000, rabbit monoclonal antibody) was purchased from Cell Signaling (Danvers, Mass., USA). Anti-Tim2 (1:2000, rabbit monoclonal antibody) was custom produced by Covance (Princeton, N.J., USA). Anti-CXCR4 (1:500, rabbit polyclonal antibody) was purchased from Abcam (Cambridge, England). Anti-Sema4A (1:200, rabbit polyclonal antibody) was purchased from Abcam. Anti-actin (1:3000, mouse monoclonal antibody) was purchased from Sigma. Myelin blots were probed for myelin basic protein (MBP) or actin for 16 h at 4° C. Anti-MBP (1:1000, rabbit monoclonal antibody) was purchased from Abcam. Corresponding anti-rabbit or anti-mouse HRP-conjugated secondary antibodies were used (1:5000, GE Amersham, Amersham, UK). Protein was visualized with enhanced chemiluminescent (ECL) reagents (Perkin-Elmer, Waltham, Mass., USA) on the FujiFilm LAS-3000 System and Image Reader LAS-3000 software. Densitometry quantification was performed using MultiGauge software.

Myelin Isolation

MBP was evaluated in the myelin fraction from the brain tissue of mice as previously described (Norton et al., 1973, J Neurochem, 21:749-757). One cerebral hemisphere (excluding the cerebellum) from each mouse was homogenized in 0.32 M sucrose and was layered onto 0.85 M sucrose. An aliquot of homogenate was removed before further myelin purification to evaluate the whole brain homogenate fraction. The layered sucrose gradient was centrifuged at 75,000 g for 30 min to allow for the collection of crude myelin. Subsequently, the sample was centrifuged at 75,000 g for 15 min in water with protease inhibitors, followed by 12,000 g for 10 min. Pellets were frozen at −80° C. Pellets were lyophilized for 16 h with a Lyo-Centre VirTis lyophilizer (SP Scientific, Warminster, Pa., USA). The lyophilized sample was resuspended in Radio-Immunoprecipitation Assay (RIPA) buffer containing protease inhibitors (Sigma, St. Louis, Mo., USA). Samples were centrifuged at 100,000 g for 45 min and supernatants were collected. Protein content was determined by bicinchoninic acid assay (BCA) assay (Pierce, Rockford, Ill., USA) and used for western blot analysis.

Immunohistochemistry

Immunostaining was performed to evaluate relative Sema4A and MBP levels in the brain. Frozen brains from both uninfected and infected mice were sectioned on a cryostat into 10 um sections. Slides were frozen until use, at which time they were fixed with 4% paraformaldehyde, washed in PBS and then blocked in 2% milk PBS for 1 h at room temperature. Slides were then probed for Sema4A or MBP for 16 h at 4° C. in 1% milk PBS supplemented with 0.1% Triton-X. Anti-Sema4A (1:100 rabbit polyclonal antibody) was purchased from Abcam. Anti-MBP (1:100 mouse monoclonal antibody) was purchased from Abcam. After washing in PBS, the slides were incubated in corresponding secondary antibody (anti-rabbit AlexaFluor 488 1:200; anti-mouse AlexaFluor 555 1:200, Invitrogen) in 1% milk PBS supplemented with 0.1% Triton-X for 1 h at room temperature together with DAPI (1:1000, Invitrogen). Slides were viewed on a Nikon Eclipse 80i microscope at 10× magnification.

ELISAs

Plasma was collected from all animals by cardiac puncture at the time of euthanasia followed by centrifugation to remove RBCs. When infected mice became moribund, blood was collected from the infected mouse and an uninfected mouse that was selected at random from a pool of diet, gender and genotype matched animals. ELISA was performed for Epo and IL-6 on the plasma. Plasma was used at a dilution of 1:10 in the assay according to the manufacturer's protocol for mouse Epo detection (R&D Systems, Minneapolis, Minn., USA) and at a dilution of 1:2 for mouse IL-6 detection (R&D Systems). Concentrations were determined utilizing a four parameter logistic nonlinear regression curve using myassays.com.

Statistical Analysis

Parasitemia and hematological parameters were analyzed by repeated measures two-way ANOVA, conducted using the mixed procedure in SAS 9.3 with Tukey's post-hoc comparisons when appropriate. All tests were two-tailed with significance set at P<0.05. Survival was analyzed by the Kaplan-Meier survival curve using Graph Pad Prism 4. Western blot and ELISA analyses were done by two-way ANOVA followed by Bonferroni post-hoc test.

The results of the experiments are now described.

### Effect of Malaria on Standard CM Model

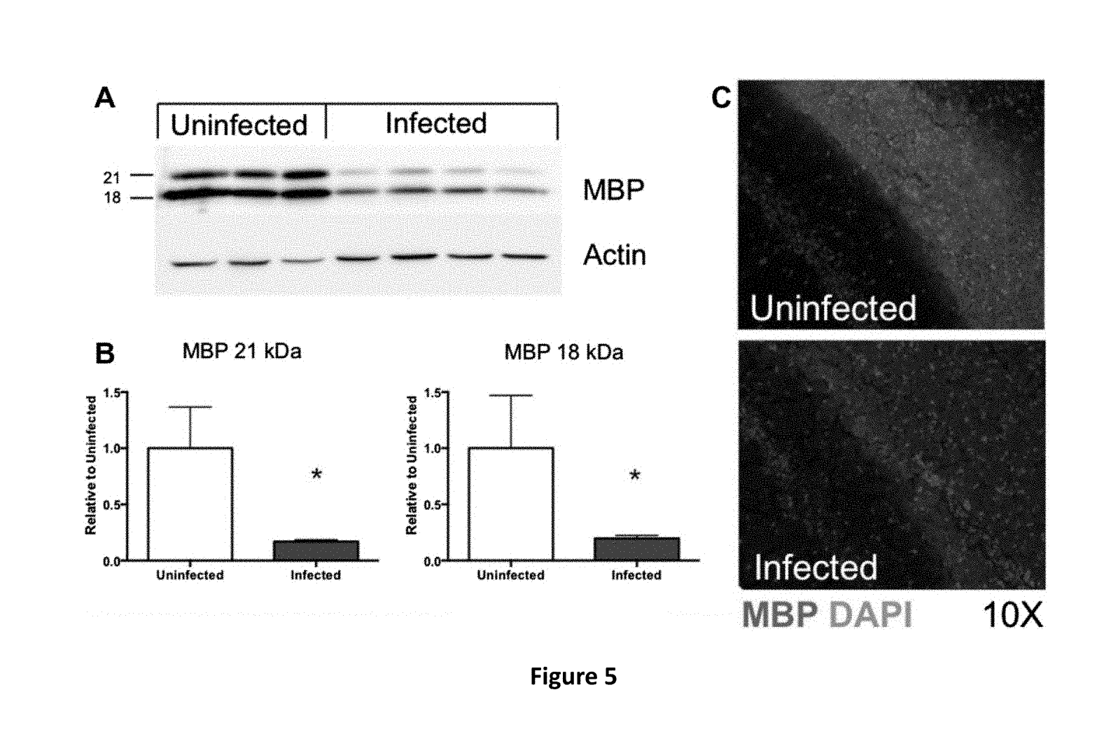

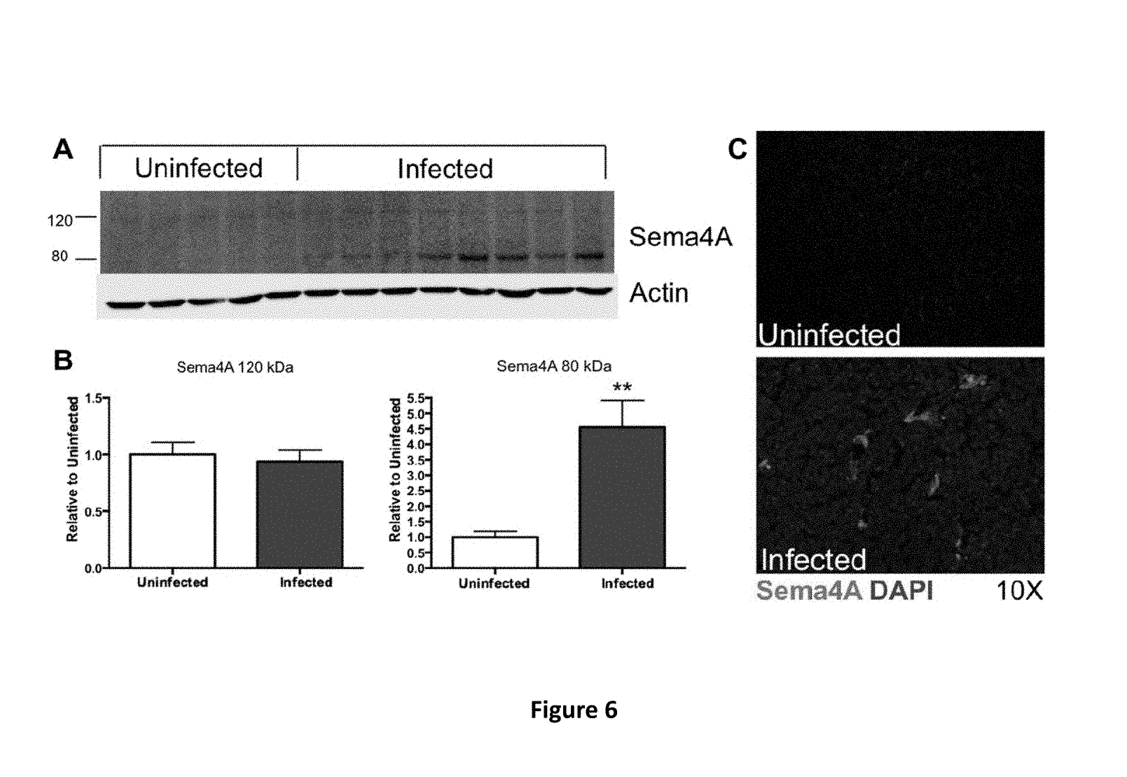

The brain tissue in the standard ECM mouse model, in which C57BL/6 mice are infected with P. berghei ANKA strain, was evaluated. The demyelination in this model has been well characterized, including the presence of neuroinflammation (Ma et al., 1997, Glia, 19:135-151; Medana et al., 2001, Cell Biol, 79:101-120; Hunt et al., 2003, Trends Immunol, 24:491-499; Hempel et al., 2012, Malar J, 11:216; Miranda et al., 2013, Malar J, 12:388). To determine the effect on myelin, western blots were performed on the myelin fraction isolated from brain. Both the 21 kDa (P<0.05) and 18 kDa isoforms (P<0.05; FIGS. 5A and 5B) of MBP decreased by approximately 80%. Histologically, reduced intensity of staining for MBP in the corpus callosum of ECM mice compared with uninfected animals (FIG. 5C) was found. After 7 days of infection, Sema4A protein levels were evaluated. Sema4A (80 kDa) increased by 4.5-fold in the brain of mice with ECM compared with uninfected controls (P<0.01; FIGS. 6A and 6B), however the 120 kDa form of Sema4A remained unchanged after infection. Histologically, there was increased intensity in staining for Sema4A in cellular clusters within the frontal cortex (FIG. 6C) but not in other regions of the brain. The data from the standard ECM model are included for comparison with the novel models introduced in this study.

### Effect of Iron Status on Malaria

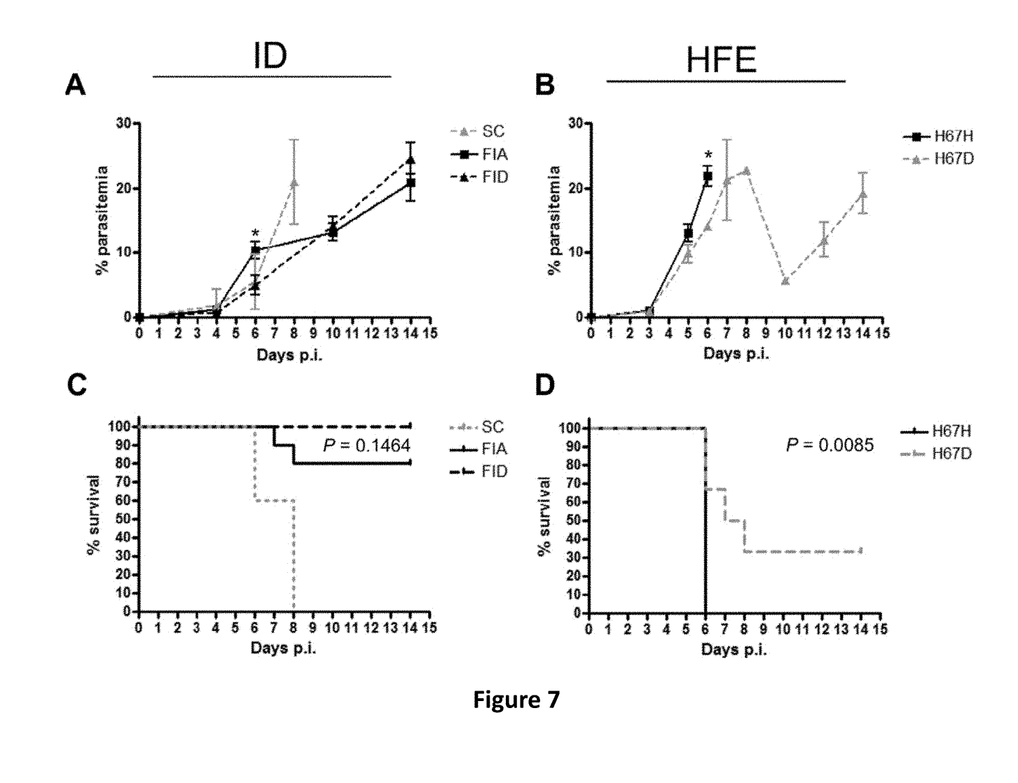

To determine the effect of iron status on the outcome and pathogenesis of ECM, mice that were ID and those homozygous for H67D HFE following P. berghei ANKA strain infection were evaluated. It was found that parasitemia was significantly lower in mice on the ID formulation diet compared with the iron adequate formulation on day 6 p.i. The level of parasitemia in the ID diet group was similar to the group on standard rodent chow. Parasitemia increased throughout the course of the infection in all dietary groups. There was no longer any statistical difference by day 10 p.i. (FIG. 7A). In the H67D mice, parasitemia was lower on day 6 p.i. compared with H67H mice (P<0.05, FIG. 7B). The parasitemia decreased by day 10 p.i. in the H67D mice and subsequently increased, most likely due to an increase in infected reticulocytes.

### Effect of Iron Status on Survival

Animals on the designed formulation diets survived beyond those mice on standard rodent chow (FIG. 7C) regardless of dietary iron status. The survival of wild type (WT) C57BL/6 mice in the standard ECM model was similar to what has been reported in a number of studies (Rest, 1982, Trans R Soc Trop Med Hyg, 76:410-415; Neill et al., 1992, Parasitology, 105(Pt 2):165-175; Ma et al., 1997, Glia, 19:135-151). However, survival was not significantly altered between the animals on the different formulation diets (P=0.1464, FIG. 3C). None (0/10) of the animals fed the ID formulation died and only two out of 10 of the mice on the iron adequate formulation died. H67D mice had a significantly better survival rate than H67H mice (P=0.0085, FIG. 7D). On day 6 p.i., 100% of infected H67H mice were moribund compared with 67% of the H67D mice. By day 14 p.i. 33% of H67D mice were still alive when they were euthanized for further evaluation.

### Effect of Iron Status on Anemia and Hematologic Parameters

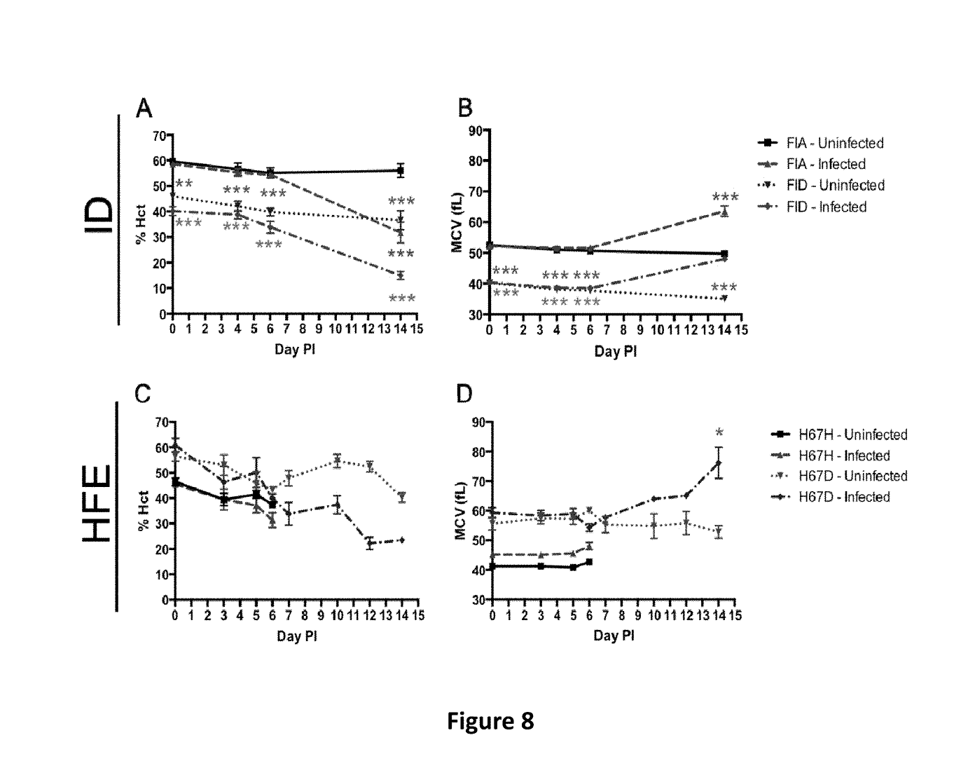

Two weeks of the ID formulation diet (day 0 p.i.) resulted in decreased hematocrit (Hct) and MCV compared with mice fed the iron adequate formulation (FIGS. 8A and 8B), indicating that the mice on the ID formulation were anemic as expected, but that adequate amounts of iron were being absorbed by mice fed the iron adequate dietary formulation. After infection, the differences in Hct and MCV between mice on the formulation diets persisted. In the infected mice, the Hct dropped and the MCV increased during the latter stages of infection, regardless of diet, due to an increase in reticulocytes.

H67D mice had higher Hct and MCV than H67H mice pre-infection (day 0 p.i. FIGS. 8C and 8D). After infection these differences continued until day 6 p.i. when H67H mice died. The MCV of the surviving H67D mice began to increase from days 12-14 p.i. due to increased reticulocytosis.

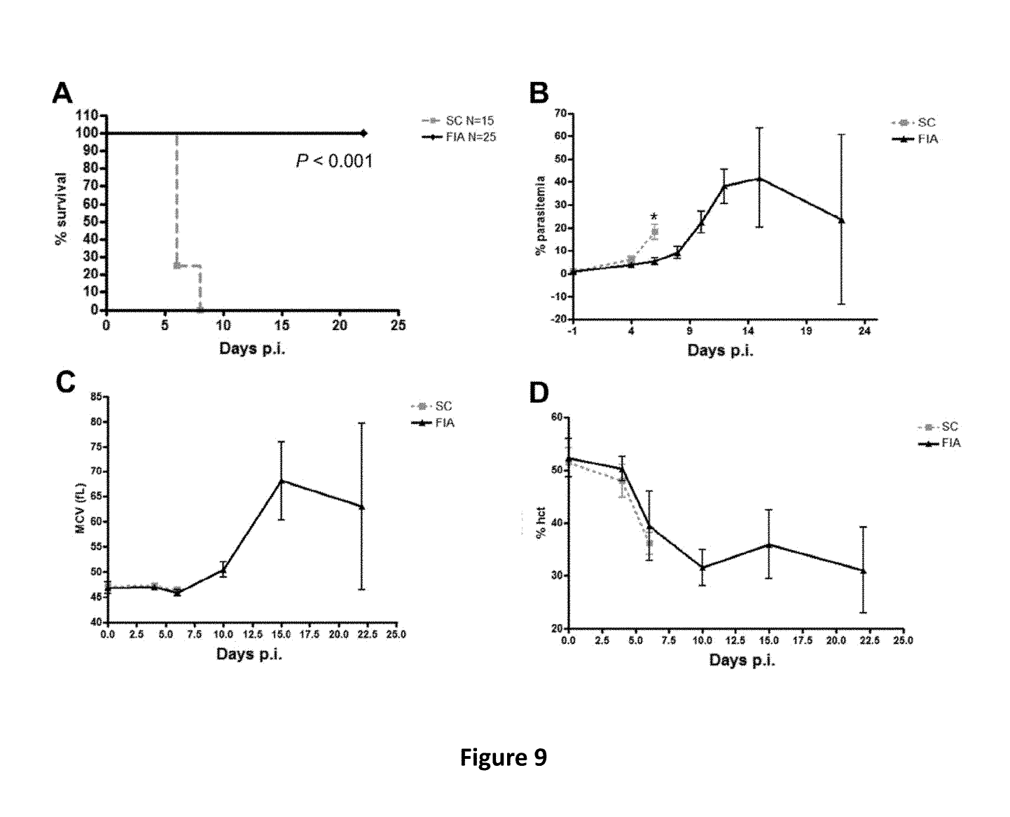

The unexpected and dramatic effect of the iron adequate diet compared with the standard rodent chow on survival caused us to repeat the experiment two additional times comparing only the standard rodent chow group with the special iron adequate formulation diet group. The results shown in FIG. 9 further confirm that the special iron adequate formulation diet is associated with increased survival, which in these experiments extended to 22 days p.i. before the study was terminated (FIG. 9A). The animals on the special iron adequate diet also had a slower rate of infection (FIG. 9B), not reaching levels seen in the animals on standard rodent chow until 10 days p.i. and continuing to rise until 15 days p.i. MCV and RBC density were similar for the two diet groups for the first 7 days p.i. (FIGS. 9C and 9D).

### Effect of Iron Status on Brain Iron Homeostatic Proteins During Malaria

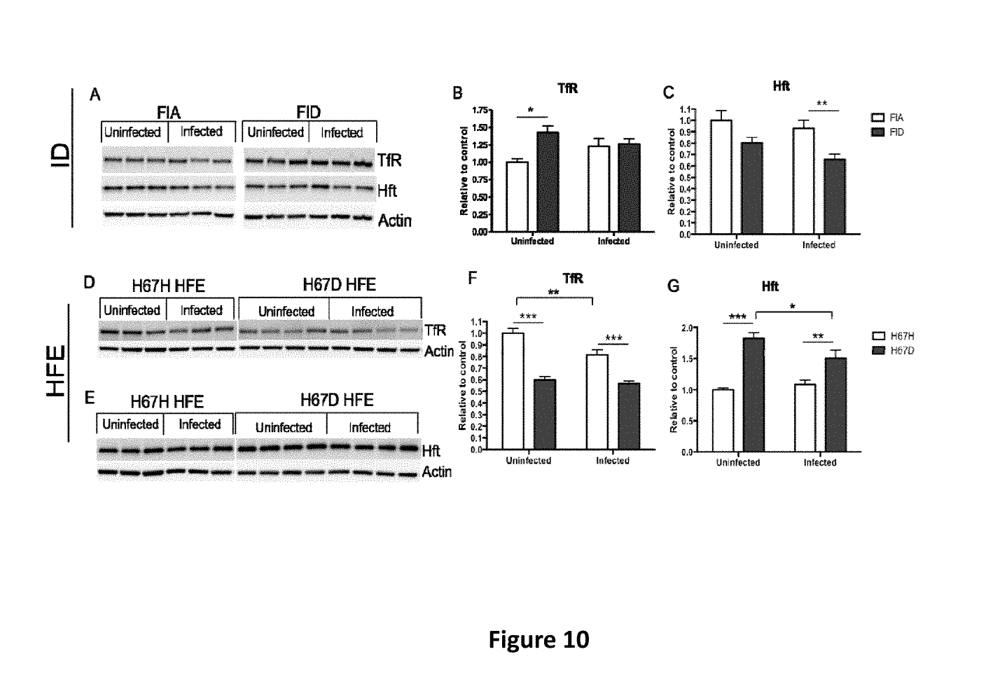

Iron homeostatic proteins in the brain were evaluated in order to determine whether iron status or infection had an effect on their expression. In the ID formulation group, TfR was significantly increased in the uninfected group compared with the iron adequate group (FIGS. 10A and 10B). However, in the infected animals TfR was not significantly altered in either diet group. The lack of difference in TfR between the mice on the formulation diets appears to be due to the 25% increase in TfR in the infected mice on the iron adequate formulation. The levels of Hft were decreased by 20% (not significant) in the brain of mice fed the ID formulation, consistent with iron deficiency, and the levels decreased further with infection (P<0.01; FIGS. 10A and 10C). In H67D mice, TfR was significantly decreased compared with H67H, consistent with elevated iron status, and remained low during infection (FIGS. 10D and 10F). TfR was also decreased by infection in H67H mice compared with H67H uninfected mice (FIGS. 10D and 10F). Hft was significantly elevated in the H67D mice compared with H67H mice, consistent with higher iron status. Following infection, Hft levels decreased in H67D mice but remained elevated compared with H67H mice (FIGS. 10E and 10G).

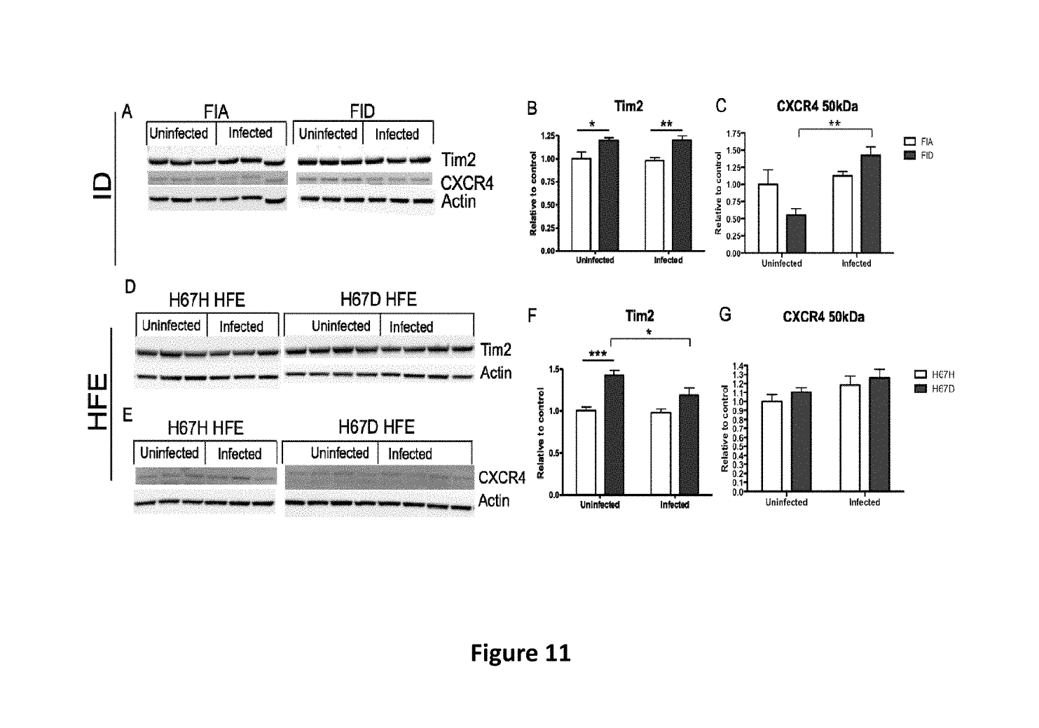

The expression of Tim2 and CXCR4 was evaluated in the different models, due to their expression on oligodendrocytes and their role in ferritin uptake and interaction with Sema4A (Kumanogoh et al., 2002, Nature, 419:629-633; Li et al., 2006, J Biol Chem, 281:37616-37627; Todorich et al., 2008, J Neurochem, 107:1495-1505; Todorich et al., 2011, Glia, 59:927-935; Patel et al., 2010, Proc Natl Acad Sci USA, 107:11062-11067). Tim2 levels in the brain were increased in mice fed the ID formulation compared with mice on the iron adequate formulation regardless of infection status (FIGS. 11A and 11B). CXCR4 was 40% lower (not significant) in mice fed the ID formulation compared with mice fed the iron adequate formulation, but its levels increased after infection (P<0.01; FIG. 11C). In H67D mice, Tim2 was elevated compared with H67H mice, but in the infected mice there was no difference in Tim2 expression. However, the expression of Tim2 in the brain of infected H67D mice decreased after infection compared with uninfected mice (P<0.05; FIGS. 11D and 11F). CXCR4 was not altered by genotype or infection (FIGS. 11E and 11G).

### Effect of Iron Status on Brain Myelin Proteins During ECM

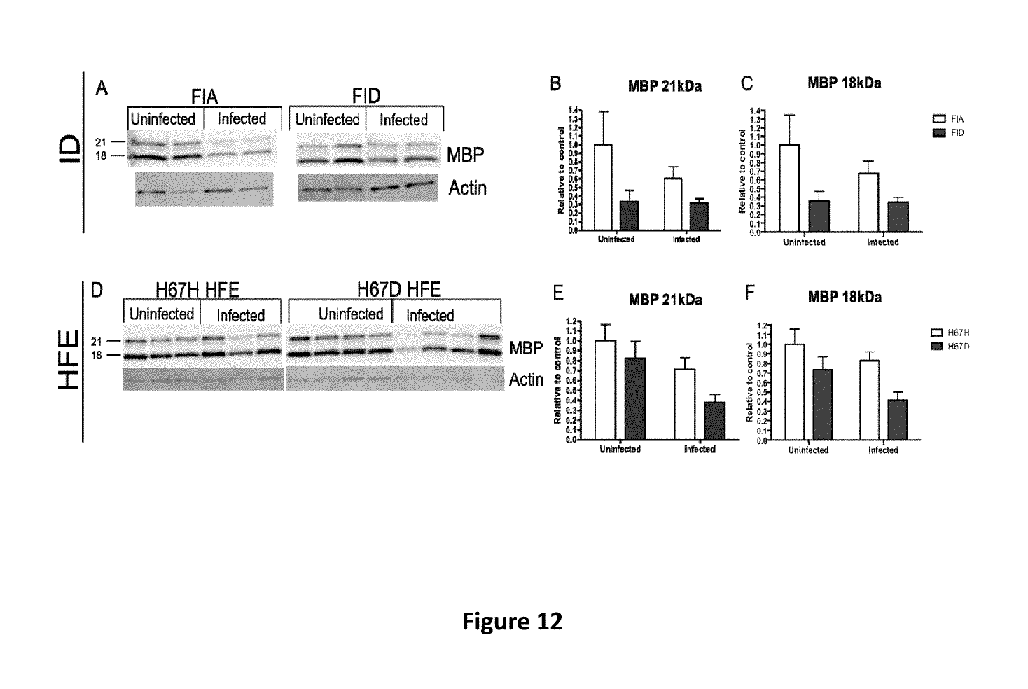

Because CM and ECM can lead to demyelination (FIG. 5, (Ma et al., 1997, Glia, 19:135-151; Dorovini-Zis et al., 2011, Am J Pathol, 178:2146-2158) and iron dysregulation (Ganz, 2009, Curr Opin Immunol, 21:63-67; Wessling-Resnick, 2010, Annu Rev Nutr, 30:105-122)), MBP expression in the myelin fraction of the ID and H67D models was evaluated. As expected, mice fed the ID diet had less MBP (67% for 21 kDa and 64% for 18 kDa) although these large differences did not reach statistical significance (FIGS. 12A-C). Infected mice on the iron adequate formulation had lower expression of the MBP 21 kDa isoform than the uninfected mice (P=0.01). A similar effect on the 18 kDa isoform did not reach statistical significance. Mice on the ID formulation had lower expression of both MBP isoforms, regardless of infection status, compared with mice on iron adequate diets (FIGS. 12A-C). The 21 kDa and 18 kDa isoforms of MBP tended to be lower in H67D mice than in the H67H mice but the difference only approached significance for infected mice (P=0.11) (FIGS. 12D-F).

### Effect of Iron Status on Inflammatory Proteins

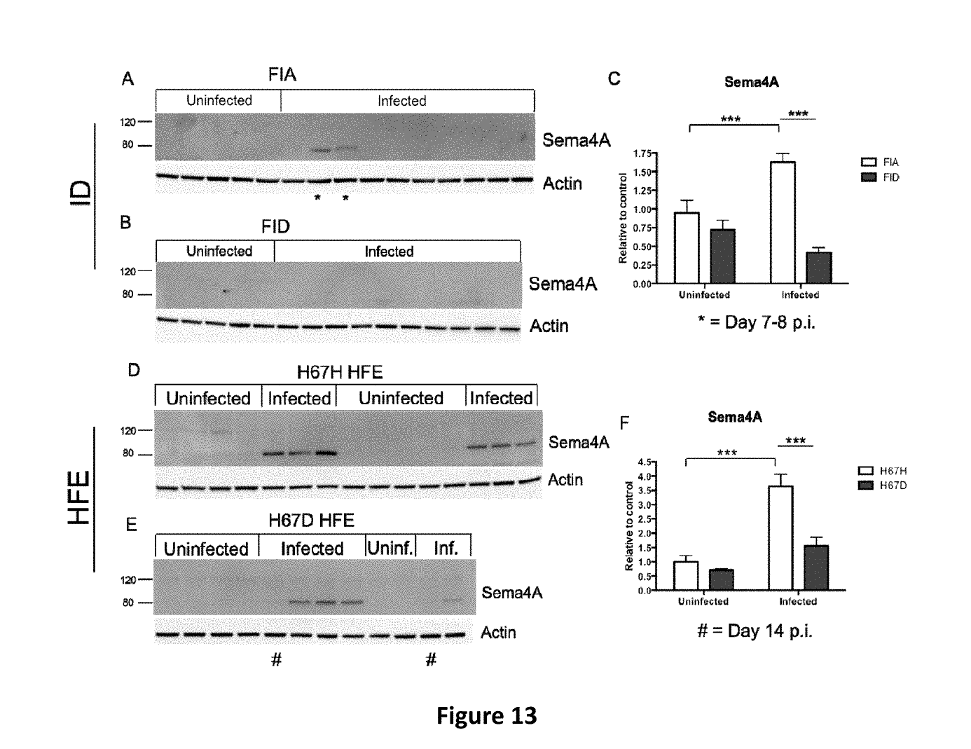

It was previously found that Sema4A is cytotoxic to oligodendrocytes (Leitner et al., 2015, ASN Neuro, 7:1-13) and Sema4A expression is increased in the brain of WT mice with ECM as shown in FIG. 6. Thus, it was evaluated whether brain Sema4A expression in infected mice is affected by iron status. There was no difference in Sema4A in the brains of uninfected mice on the formulation diets. Infection resulted in a nearly two-fold increase in brain Sema4A in mice on the iron adequate formulation (P<0.001, FIGS. 13A and 13C). However, mice on the ID formulation had no significant change in brain Sema4A after infection. The H67D mice had levels of Sema4A similar to H67H in the uninfected groups but with infection there was a dramatic increase in Sema4A in infected H67H and a lesser increase in infected H67D mice (FIGS. 13D and 13F).

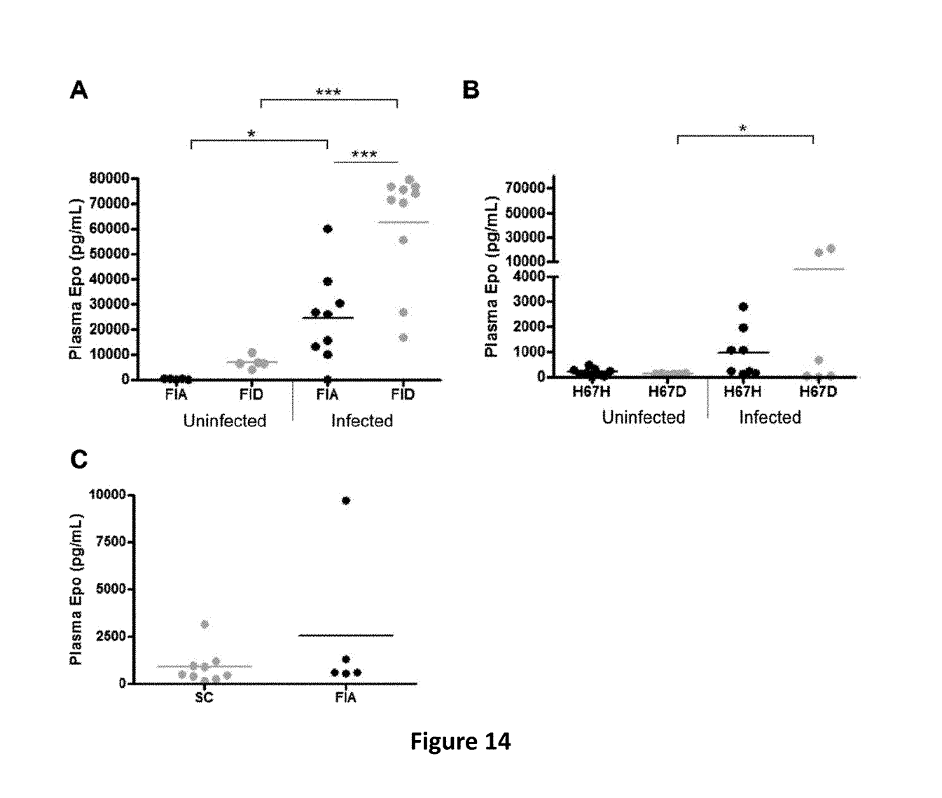

Plasma Epo and IL-6 levels were evaluated because those are important components of the iron-erythropoiesis axis (Pak et al., 2006, Blood, 108:3730-3735; Zarychanski et al., 2008, CMAJ, 179:333-337; Nairz et al., 2012, Microbes Infect, 14:238-246). Plasma was obtained from each infected mouse at the time of euthanasia and from an uninfected mouse to serve as a matched control. Uninfected mice on the ID formulation had a slightly elevated Epo compared with uninfected animals on the iron adequate formulation but this 27% difference was not statistically significant (FIG. 14A). Infection of mice on the formulation diets resulted in dramatic increases in levels of Epo, and mice on the ID diet had the highest Epo levels.

Epo levels were similar in the uninfected H67H and H67D mice but elevated in infected H67D mice that survived compared with uninfected mice. Infected H67H mice had lower Epo levels than H67D mice but the difference was not statistically significant (FIG. 14B).

Epo levels were measured in the plasma of the animals evaluated in the additional survival study (FIG. 14C). The levels of Epo were evaluated at day 6 p.i. for both groups. There were no differences between the two diet groups at this stage of infection.

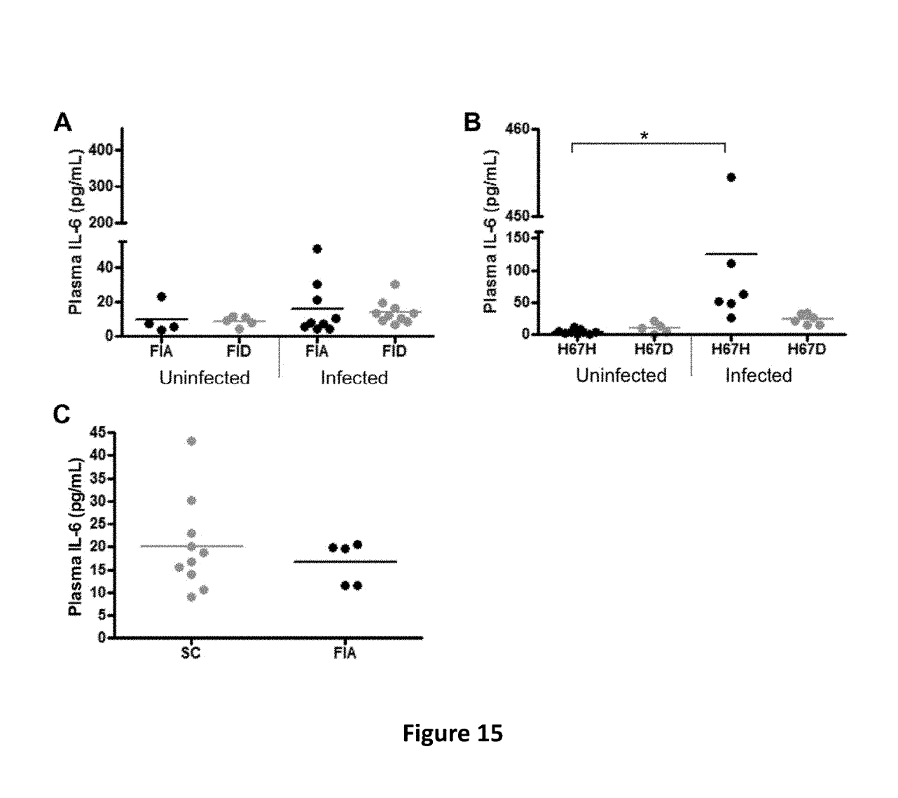

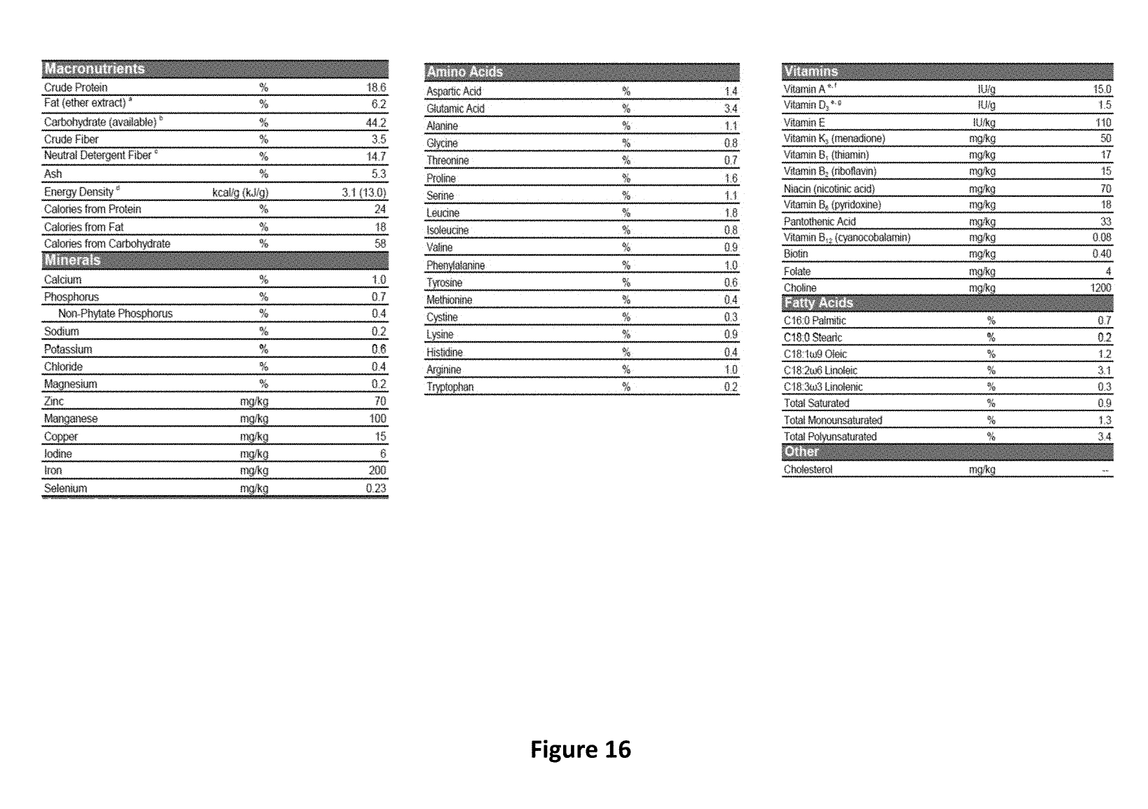

Infection had no significant effect on IL-6 levels of mice on the formulation diets (FIG. 15A). On the other hand, H67H mice had higher IL-6 levels than H67D mice during infection (FIG. 15B). The levels of IL-6 were also determined in plasma of mice 6 days p.i. in the long-term survival study and no differences were found between the two formulation diet groups (FIG. 15C), although there was much greater variability in the group fed standard rodent chow.

### Dietary Intervention Strategy

The interplay between iron levels and susceptibility to malaria is important but not well understood. Iron deficiency has been shown to limit parasitemia while iron supplementation in some studies has been shown to be detrimental. In order to further elucidate the relationship between iron and malaria, the effect of iron deficiency anemia and a gene variant typically associated with elevated iron (H67D) in a well-described ECM model was studies. A formulation for the ID diet that controlled for composition was developed, termed the iron adequate formulation to distinguish it from “control” diets which are standard rodent chow. In this study, it was demonstrated that the formulation diets, regardless of iron content, and homozygosity for the H67D allele delayed parasitemia and improved survival. The iron adequate formulation dramatically improved survival compared with mice receiving standard rodent chow. The mice fed the ID formulation had a decreased infection rate and greater survival. Although this finding was consistent with a previous report (Koka et al., 2007, Biochem Biophys Res Commun, 357:608-614), the mice in our study were much younger and more closely represent the majority of CM cases. Overall, the mice that survived the longest consistently had increased plasma Epo and lower plasma IL-6; although these differences were not apparent in the long-term survival group at just 6 days p.i. when the shorter term survival animals were moribund. Epo has previously been reported to have protective effects in CM and ECM (Kaiser et al., 2006, J Infect Dis, 193:987-995; Bienvenu et al., 2008, Acta Trop, 106:104-108; Casals-Pascual et al., 2008, Proc Natl Acad Sci USA, 105:2634-2639; Casals-Pascual et al., 2009, Trends Parasitol, 25:30-36; Wiese et al., 2008, Malar J, 7:3; Hempel et al, 2011, Am J Pathol, 179:1939-1950; Hempel et al., 2012, Malar J, 11:216; Wei et al., 2014, Infect Immun, 82:165-173). Elevated IL-6 is associated with more severe malaria infection (Lyke et al., 2004, Infect Immun, 72:5630-5637). It was recently showed that Sema4A exposure is cytotoxic to oligodendrocytes (Leitner et al., 2015, ASN Neuro, 7:1-13). The increased expression of Sema4A in the brain tracked consistently with decreased myelin, suggesting that limiting the expression of this protein in the brain may be part of a positive outcome profile.

It was expected to found that mice with the H67D allele and those on the iron adequate formulation would show greater vulnerability to ECM based on current thinking regarding the relationship between iron status and malaria. However, these mice showed more resistance. One possible explanation is that normal iron status or even elevated iron status is not detrimental in the setting of malaria infection. Although H67D homozygous mice have increased body iron stores, this does not mean that they are available to the parasite. However, the iron is bioavailable in both the H67D mice and the mice fed the iron adequate formulation in at least normal amounts based on the hematologic measurements and the expression of TfR, ferritin and MBP status in the brain. Moreover, our data suggest that Epo and IL-6, and maybe Sema4A, play a critical role in limiting the consequences of ECM. The observation that mice on the formulation diets survived longer than mice on standard rodent chow, regardless of iron content, indicates that there are additional properties of the diet that counteracted the effects that lead to ECM. The active components of the diet are under investigation, but the diet itself may be a functional food that could be used to limit or manage the deleterious effects of CM and ID. Because parasitemia increased in the animals on the adequate iron formulation diet, it is likely that the diet would be given in combination with anti-malarial agents.

Iron deficiency is a common problem in regions endemic for CM. Iron deficiency during post-natal development has a significant and long-term effect on cognitive and motor performance, so the evaluation of a model that can limit iron deficiency and still provide protection from CM would enhance the overall health of the at risk population. In animals exposed to the ID formulation, expression of a number of brain iron homeostatic proteins were altered and these expression profiles were influenced by infection. For example, the mice on the ID diet had increased TfR, a trend of decreased Hft, increased Tim2, and a trend in decrease of CXCR4. TfR is the primary mechanism for neuronal iron uptake and ferritin functions to store iron in cells. Therefore the changes in the expression of these proteins after iron deficiency indicate that the brain has insufficient iron. Tim2 is expressed by oligodendrocytes and acts as the receptor for Hft to facilitate iron delivery and initiate a trophic signal in these cells (Todorich et al., 2008, J Neurochem, 107:1495-1505; Todorich et al., 2011, Glia, 59:927-935). CXCR4 is also expressed by oligodendrocytes and interacts with Hft, playing a role in oligodendrocyte differentiation and myelination (Li et al., 2006, J Biol Chem, 281:37616-37627; Patel et al., 2010, Proc Natl Acad Sci USA, 107:11062-11067). The changes in these proteins suggest decreased iron availability to oligodendrocytes, which is consistent with the 65% decrease in levels of MBP seen even in the short time course the mice were fed the ID formulation. The decrease in myelination is consistent with various models of iron deficiency (Beard et al., 2003, Dev Neurosci, 25:308-315; Ortiz et al., 2004, J Neurosci Res, 77:681-689).

After infection, the levels of Hft that had trended downward in the ID mice reached statistical significance. This reduction in Hft expression could include secreted Hft from microglia, which would further contribute to decreased myelin because oligodendrocytes utilize Hft secreted by microglia as an iron source and trophic factor (Zhang et al., 2006, Glia, 54:795-804; Todorich et al., 2011, Glia, 59:927-935; Schonberg et al., 2012, J Neurosci, 32:5374-5384). The reduction in Hft can also reflect decreased neuroprotection (Regan et al., 2002, Neuroscience, 113:985-994; Torti et al., 2002, Blood, 99:3505-3516; Pham et al., 2004, Cell, 119:529-542). The lower levels of CXCR4 in the ID mouse brains were increased after infection. Changes in CXCR4 may be due to an increased number of oligodendrocyte progenitor cells (OPCs) arrested in an earlier stage of differentiation and/or related to infiltrating peripheral inflammatory cells, as CXCR4 is expressed by T cells in addition to oligodendrocytes (Sloane et al., 2005, Immunol Cell Biol, 83:129-143; Patel et al., 2010, Proc Natl Acad Sci USA, 107:11062-11067). The impact of CM on oligodendrocyte development is unknown. Infection had no effect on Tim2 expression in either formulation diet group. MBP was decreased by infection but there was no additive effect to the decrease in MBP with both infection and the ID formulation diet suggesting that iron deficiency could impact expression of MBP as severely as CM and ECM.

The second animal model that was investigated in this study provided the opportunity to evaluate the effect of genetically driven iron overload on the outcome of ECM. This animal model not only provided a model in which to interrogate the current paradigm on iron status in conjunction with ECM but is also relevant to the human population because HFE polymorphisms are prevalent in Caucasians who are at risk for CM when traveling to endemic regions (AFHSC, 2014, MSMR, 21:4-7). The relative increase in survival of H67D HFE mice was unexpected because it has been reported that elevated iron increases the incidence of various infections (Khan et al., 2007, Int J Infect Dis, 11:482-487; Benesova et al., 2012, PLoS One, 7:e39363). It was already reported that brain and liver iron accumulation occurs in the H67D HFE mouse model (Tomatsu et al., 2003, Proc Natl Acad Sci USA, 100:15788-15793; Nandar et al., 2013, Biochim Biophys Acta, 1832:729-741). However, there are reports of increased survival after Salmonella typhimurium infection with an HFE deficit (Wang et al., 2008, J Immunol, 181:2723-2731; Wang et al., 2009, J Clin Invest, 119:3322-3328). The mechanism of increased survival appears related to limiting the inflammatory response. IL-6 increases after malaria infection and is associated with increasing severity of symptoms (Lyke et al., 2004, Infect Immun, 72:5630-5637). IL-6 levels were less in the H67D mice p.i. compared with the WT. The genotype-specific inflammatory response may relate to the iron status of the macrophages that can be altered by HFE genotype (van Asbeck et al., 1982, Br Med J (Clin Res Ed), 284:542-544; van Asbeck et al., 1984, J Infect, 8:232-240; Moura et al., 1998, Eur J Clin Invest, 28:164-173; Wang et al., 2008, J Immunol, 181:2723-2731; Wang et al., 2009, J Clin Invest, 119:3322-3328).

After infection, brain iron homeostatic proteins were altered in H67H and H67D HFE mice. The changes in these iron homeostatic proteins reflect a level of iron dysregulation that may impact myelin. Indeed, MBP was reduced 20-30% in H67H and 60% in H67D HFE mice in the infected groups. In addition to brain iron homeostatic protein expression, the extent of the inflammatory response in brain and plasma after infection was impacted by iron status and genotype. In general, the animals surviving the longest consistently had decreased Sema4A in the brain, increased Epo and decreased IL-6 in plasma. Sema4A is a ligand of Tim2 and is cytotoxic to oligodendrocytes. Its expression is increased in microglia upon activation (Leitner et al., 2015, ASN Neuro, 7:1-13). Blocking antibodies to Sema4A result in decreased neurological severity in experimental autoimmune encephalomyelitis (EAE) (Kumanogoh et al., 2002, Nature, 419:629-633). Additionally, elevated levels of Sema4A in serum have been associated with Th17 skewing in Multiple Sclerosis patients who also have demyelination (Nakatsuji et al., 2012, J Immunol, 188:4858-4865). These data combined with our findings suggest minimizing Sema4A in the brain may limit the extent of demyelination.

In addition to decreased Sema4A, all surviving animals had elevated Epo and reduced IL-6 plasma levels regardless of diet or genotype. Normally, inflammation is associated with Epo resistance (Macdougall et al., 2002, Nephrol Dial Transplant, 17 Suppl 11:39-43); blocking erythropoietic effects and the activity of Epo in immunomodulation and neuroprotection. In both ID and H67D HFE mice, there was an increase in reticulocytes that coincides with the increased Epo in surviving mice. Moreover, the animals on the iron adequate formulation had increased Epo compared to H67H mice on standard rodent chow. IL-6 increases after malaria infection and is associated with increasing severity of symptoms (Lyke et al., 2004, Infect Immun, 72:5630-5637). In this study, IL-6 was lowest in mice surviving longest. For example, H67H mice had IL-6 levels up to 30-fold higher than uninfected mice.

Despite differences between murine ECM compared with human CM, there are also similarities such as the standard ECM animal model displays BBB permeability, myelin damage and axonal damage (Ma et al., 1997, Glia, 19:135-151; Dorovini-Zis et al., 2011, Am J Pathol, 178:2146-2158), and many studies have found that ECM animal models are informative and vital to the progress of the field (Hunt et al., 2010, Trends Parasitol, 26:272-274; Riley et al., 2010, Trends Parasitol., 26:277-278; Stevenson et al., 2010, Trends Parasitol., 26:274-275).

In conclusion, it appears that limiting access of Sema4A to the brain, increasing Epo and maintaining lower levels of IL-6 may promote survival and minimize damage associated with ECM. Contrary to prevailing opinion, normal amounts of dietary iron or even elevated iron stores are not sufficient to enhance the infection and cause subsequent brain damage. Indeed our data suggest that it is possible that a dietary intervention strategy can be developed to maintain normal iron levels yet limit the neurological effects from malarial infection. These findings are critical to the current debate regarding iron deficiency and its well-established effects on brain development and the impact of CM on neurological function. Clearly further analyses are warranted to evaluate the mechanism by which the novel diet introduced in this study and the H67D HFE genotype limit neurological involvement in the ECM model, as well as an investigation into the possible extension of our findings to CM.

Contrary to prevailing opinion iron status does not predict survival outcome in CM. Moderating inflammation is more important than iron status for survival following CM. Elevated Sema4A in brain is associated with increased loss of myelin basic protein. A diet to provide adequate iron but dampen the immune response is disclosed herein.

The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. A medical food comprising at least one protein, at least one sugar, at least one fat, at least one vitamin, and at least one mineral.

2. The medical food of claim 1, wherein:
the at least one protein is a protein found in casein, the at least one sugar is sucrose, and the at least one fat is a fat found in corn oil,
the at least one vitamin is selected from the group consisting of thiamin, riboflavin, pyridoxine, niacin, calcium pantothenate, folic acid, biotin, vitamin B12, vitamin A, vitamin E, DL-alpha tocopheryl acetate, vitamin D3, cholecalciferol, and vitamin K, and
the at least one mineral is selected from the group consisting of calcium, phosphorus, potassium, sodium, chlorine, magnesium, copper, iron, zinc, manganese, iodine, and selenium.

3. The medical food of claim 2 further comprising methionine, corn starch, and choline.

4. The medical food of claim 2, wherein casein is low Cu and Fe casein.

5. The medical food of claim 1, wherein the medical food further comprises an iron source.

6. The medical food of claim 5, wherein the concentration of iron in the medical food is up to about 1000 mg/Kg.

7. The medical food of claim 5, wherein the iron source is ferric citrate.

8. The medical food of claim 3, wherein choline is in the form of choline bitartrate.

9. The medical food of claim 1, further comprising an antioxidant.

10. The medical food of claim 9, wherein the antioxidant is ethoxyquin.

11. A method for treating or preventing malaria in a subject, comprising administering to the subject an effective amount of a medical food of claim 1.

12. A method for treating or preventing a malaria associated disorder in a subject, comprising administering to the subject an effective amount of a medical food of claim 1.

13. The method of claim 12, wherein the malaria associated disorder is cerebral malaria.

14. The method of claim 11, wherein the subject is further afflicted with iron deficiency.

15. The method of claim 12, wherein the subject is further afflicted with iron deficiency.

16. The method of claim 13, wherein the subject is further afflicted with iron deficiency.

17. A method for treating or preventing iron deficiency in a subject, comprising administering to the subject an effective amount of a medical food of claim 5.

18. The method of claim 17, wherein the subject is further afflicted with malaria.

19. The method of claim 17, wherein the subject is further afflicted with a malaria associated disorder.

20. The method of claim 19, wherein the malaria associated disorder is cerebral malaria.
